(19) United States
(12) Patent Application Publication
(10) Pub. No.: US 2025/0362482 A1
(43) Pub. Date: Nov. 27, 2025

(54) IMAGING LENS AND IMAGING APPARATUS

(71) Applicant: FUJIFILM Corporation, Tokyo (JP)

(72) Inventor: Daiki KOMATSU, Saitama (JP)

(73) Assignee: FUJIFILM Corporation, Tokyo (JP)

(21) Appl. No.: 19/212,617

(22) Filed: May 19, 2025

(30) Foreign Application Priority Data
May 27, 2024 (JP) 2024-085849

(51) Int. Cl. G02B 13/00; G02B 7/02

(52) U.S. Cl. CPC G02B 13/0045; G02B 7/025; G02B 13/006

(57) ABSTRACT

An imaging lens consists of, in order from an object side to an image side, a first lens group and a second lens group. During focusing, the first lens group moves along an optical axis, and the second lens group is fixed with respect to an image plane. A lens of the first lens group closest to the object side is a negative lens. The imaging lens satisfies a predetermined conditional expression.

### CROSS-REFERENCE TO RELATED APPLICATIONS

This application claims priority from Japanese Patent Application No. 2024-085849, filed on May 27, 2024, the entire disclosure of which is incorporated herein by reference.

### BACKGROUND

### Technical Field

The technology of the present disclosure relates to an imaging lens and an imaging apparatus.

### Related Art

In the related art, a lens system disclosed in JP2021-033004A is known as an imaging lens used in a camera and the like.

### SUMMARY

There is a requirement for an imaging lens that is configured to have a small size and that has favorable optical performance. These requirement levels are increasing year by year.

The present disclosure provides an imaging lens that is configured to have a small size and that has favorable optical performance, and an imaging apparatus comprising the imaging lens.

An aspect of the technology of the present disclosure relates to an imaging lens consisting of, in order from an object side to an image side, a first lens group and a second lens group, in which, during focusing, the first lens group moves along an optical axis, and the second lens group is fixed with respect to an image plane, a lens of the first lens group closest to the object side is a negative lens, and Conditional Expression (1) is satisfied, which is represented by 1.3<TL/(f×tan ω)<2.1 (1).

Here, a sum of a distance on the optical axis from a lens surface of the first lens group closest to the object side to a lens surface of the second lens group closest to the image side and a back focus of an entire system at an air conversion distance, in a state in which an infinite distance object is in focus, is denoted by TL. A focal length of the entire system in a state in which the infinite distance object is in focus is denoted by f. A maximum half angle of view in a state in which the infinite distance object is in focus is denoted by ω.

It is preferable that the number of lenses included in the entire system is equal to or greater than 7 and equal to or less than 11.

It is preferable that, in the imaging lens according to the above-described aspect, in a case in which the back focus of the entire system at the air conversion distance in a state in which the infinite distance object is in focus is denoted by Bf, Conditional Expression (2) is satisfied, which is represented by 0.08<Bf/f<0.3 (2).

It is preferable that, in the imaging lens according to the above-described aspect, in a case in which an open F-number in a state in which the infinite distance object is in focus is denoted by FNo, Conditional Expression (3) is satisfied, which is represented by 4.3<FNo×(TL/f)<6.4 (3).

It is preferable that, in the imaging lens according to the above-described aspect, in a case in which a distance on the optical axis from the lens surface of the first lens group closest to the object side to a lens surface of the first lens group closest to the image side is denoted by dG1, Conditional Expression (4) is satisfied, which is represented by 0.45<dG1/(f×tan ω)<1 (4).

It is preferable that, in the imaging lens according to the above-described aspect, in a case in which a distance on the optical axis from a lens surface of the first lens group closest to the image side to a lens surface of the second lens group closest to the object side in a state in which the infinite distance object is in focus is denoted by dF, Conditional Expression (5) is satisfied, which is represented by 0.05<dF/(f×tan ω)<0.32 (5).

It is preferable that, in the imaging lens according to the above-described aspect, the first lens group consists of, in order from the object side to the image side, a front side partial group, a stop, and a rear side partial group, and in a case in which a focal length of the front side partial group is denoted by fG1f, and a focal length of the first lens group is denoted by fG1, Conditional Expression (6) is satisfied, which is represented by 1.8<fG1f/fG1<8 (6).

In such a case, it is preferable that, in the imaging lens according to the above-described aspect, Conditional Expression (7) is further satisfied, which is represented by 1.3<fG1f/f<5 (7).

It is preferable that, in the imaging lens according to the above-described aspect, in a case in which a focal length of the second lens group is denoted by fG2, Conditional Expression (8) is satisfied, which is represented by −2.5<fG2/f<−0.4 (8).

It is preferable that, in the imaging lens according to the above-described aspect, in a case in which a focal length of the first lens group is denoted by fG1, Conditional Expression (9) is satisfied, which is represented by 0.4<fG1/f<0.95 (9).

It is preferable that, in the imaging lens according to the above-described aspect, in a case in which a lateral magnification of the first lens group in a state in which the infinite distance object is in focus is denoted by βG1, and a lateral magnification of the second lens group in a state in which the infinite distance object is in focus is denoted by βG2, Conditional Expression (10) is satisfied, which is represented by 1.4<(1−βG1²)×βG2²<3.2 (10).

It is preferable that, in the imaging lens according to the above-described aspect, the first lens group consists of, in order from the object side to the image side, a front side partial group, a stop, and a rear side partial group, and in a case in which an average value of refractive indexes of all positive lenses included in the rear side partial group at a d line is denoted by NG1rpa, an average value of Abbe numbers of all the positive lenses included in the rear side partial group based on the d line is denoted by νG1rpa, and an average value of partial dispersion ratios of all the positive lenses included in the rear side partial group between a g line and an F line is denoted by θG1rpa, Conditional Expressions (11) and (12) are satisfied, which are represented by 1.6<NG1rpa<1.86 (11), and 0.65<θG1rpa+0.0025×νG1rpa<0.72 (12).

It is preferable that, in the imaging lens according to the above-described aspect, only one positive lens is included in the second lens group, and in a case in which a focal length of the positive lens in the second lens group is denoted by fG2p, and a focal length of the second lens group is denoted by fG2, Conditional Expression (13) is satisfied, which is represented by −4<fG2p/fG2<−1 (13).

It is preferable that, in the imaging lens according to the above-described aspect, only one positive lens is included in the second lens group, and in a case in which a refractive index of the positive lens in the second lens group at a d line is denoted by NG2p, an Abbe number of the positive lens in the second lens group based on the d line is denoted by νG2p, and a partial dispersion ratio of the positive lens in the second lens group between a g line and an F line is denoted by θG2p, Conditional Expressions (14) and (15) are satisfied, which are represented by 1.88<NG2p<1.96 (14), and 0.67<θG2p+0.0025×νG2p<0.705 (15).

It is preferable that a lens disposed on a side of the first lens group closest to the image side is a first aspherical lens having a positive refractive power.

It is preferable that the second lens group includes a second aspherical lens, and in a case in which a height from the optical axis at a position of a maximum effective diameter on an image side surface of the second aspherical lens is denoted by hE2, an arbitrary height from the optical axis is denoted by h, an amount of sag of each point on the image side surface of the second aspherical lens at the height h is denoted by Sg2(h), and a second derivative of Sg2(h) with respect to h is denoted by d²Sg2(h)/dh², in a range of 0.5×hE2≤h≤hE2 on the image side surface of the second aspherical lens, Conditional Expression (16) is satisfied, which is represented by |d²Sg2(h)/dh²|>2×|d²Sg2(h/2)/dh²| (16).

It is preferable that an object side surface of the negative lens of the first lens group closest to the object side is a concave surface.

It is preferable that the first lens group includes a stop and a single lens that is disposed adjacent to the image side of the stop and that has a positive refractive power.

It is preferable that the second lens group consists of, in order from the object side to the image side, a negative lens, a negative lens, and a positive lens.

Another aspect of the present disclosure relates to an imaging apparatus comprising the imaging lens according to the above-described aspect.

It should be noted that, in the present specification, the expressions “consists of” and “consisting of” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the shown constituents.

The term “ . . . group having a positive refractive power” in the present specification means that the entire group has a positive refractive power. The term “ . . . group having a negative refractive power” means that the entire group has a negative refractive power. The term “lens having a positive refractive power” and the term “positive lens” are synonymous. The term “lens having a negative refractive power” and the term “negative lens” are synonymous. The term “ . . . group” in the present specification is not limited to having a configuration consisting of a plurality of lenses, and may have a configuration consisting of only one lens.

The term “single lens” in the present specification means one lens that is not cemented. It should be noted that a compound aspherical lens (a lens functioning as one aspherical lens as a whole, in which a lens (for example, a spherical lens) and a film of an aspherical shape formed on the lens are configured to be integrated with each other) is not regarded as a cemented lens and is regarded as one lens. Unless otherwise noted, a sign of a refractive power and a surface shape related to a lens including an aspherical surface in a paraxial region are used.

The term “entire system” in the present specification means the imaging lens. The term “focal length” used in the conditional expressions means a paraxial focal length. Unless otherwise noted, the term “distance on the optical axis” used in the conditional expressions means a geometrical distance. Unless otherwise noted, values used in the conditional expressions are values based on a d line in a state in which the infinite distance object is in focus.

The terms “d line”, “C line”, “F line”, and “g line” described in the present specification mean emission lines, in which a wavelength of the d line is 587.56 nanometers (nm), a wavelength of the C line is 656.27 nanometers (nm), a wavelength of the F line is 486.13 nanometers (nm), and a wavelength of the g line is 435.84 nanometers (nm).

According to the present disclosure, it is possible to provide the imaging lens that is configured to have a small size and that has favorable optical performance, and the imaging apparatus comprising the imaging lens.

### BRIEF DESCRIPTION OF THE DRAWINGS

FIG. 1 is a cross-sectional view showing a configuration of an imaging lens according to an embodiment, which corresponds to an imaging lens according to Example 1.

FIG. 2 is a cross-sectional view showing a configuration and a luminous flux of the imaging lens of FIG. 1, and is a diagram showing symbols of conditional expressions.

FIG. 3 is a diagram showing a position of a maximum effective diameter.

FIG. 4 is a diagram showing an amount of sag and the like of a first aspherical lens.

FIG. 5 is a diagram showing an amount of sag and the like of a second aspherical lens.

FIG. 6 is each aberration diagram of the imaging lens according to Example 1.

FIG. 7 is a cross-sectional view showing a configuration of an imaging lens according to Example 2.

FIG. 8 is each aberration diagram of the imaging lens according to Example 2.

FIG. 9 is a cross-sectional view showing a configuration of an imaging lens according to Example 3.

FIG. 10 is each aberration diagram of the imaging lens according to Example 3.

FIG. 11 is a cross-sectional view showing a configuration of an imaging lens according to Example 4.

FIG. 12 is each aberration diagram of the imaging lens according to Example 4.

FIG. 13 is a cross-sectional view showing a configuration of an imaging lens according to Example 5.

FIG. 14 is each aberration diagram of the imaging lens according to Example 5.

FIG. 15 is a cross-sectional view showing a configuration of an imaging lens according to Example 6.

FIG. 16 is each aberration diagram of the imaging lens according to Example 6.

FIG. 17 is a cross-sectional view showing a configuration of an imaging lens according to Example 7.

FIG. 18 is each aberration diagram of the imaging lens according to Example 7.

FIG. 19 is a perspective view showing a front side of an imaging apparatus according to an embodiment.

FIG. 20 is a perspective view of a rear side of the imaging apparatus of FIG. 19.

FIG. 21 is a perspective view of a front side of an imaging apparatus according to another embodiment.

### DETAILED DESCRIPTION

Hereinafter, embodiments of the technology of the present disclosure will be described with reference to the drawings.

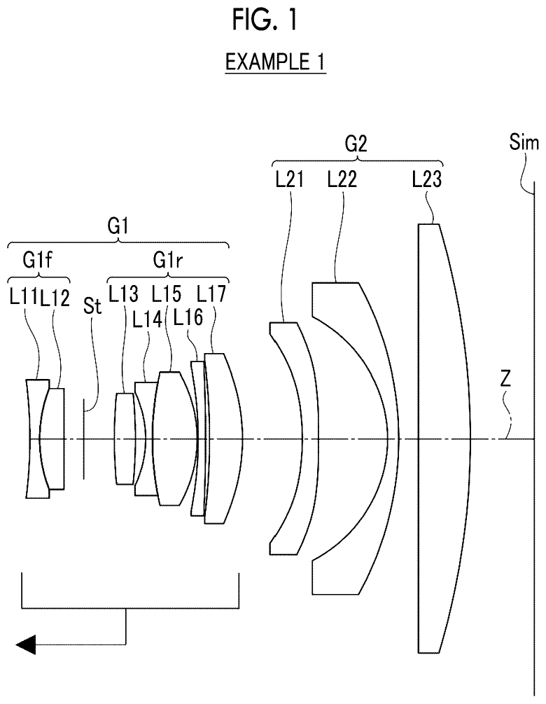

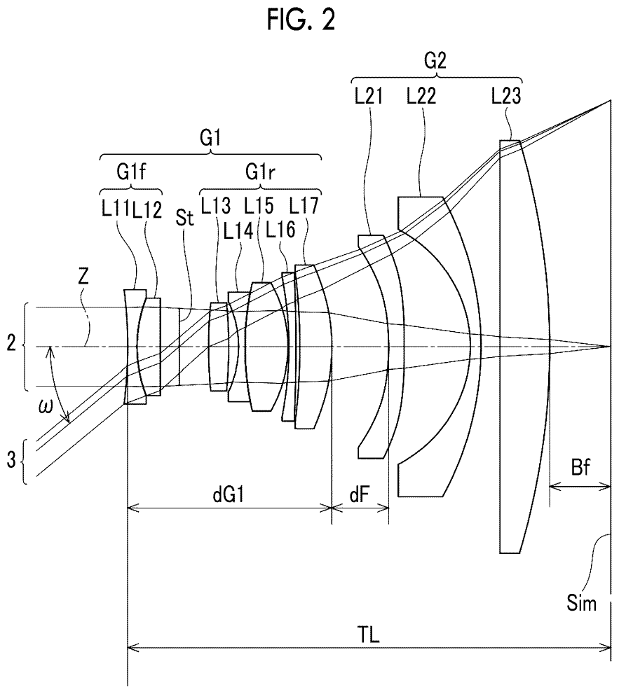

FIG. 1 shows a cross-sectional view of a configuration of an imaging lens according to the embodiment of the present disclosure. FIG. 2 is a cross-sectional view of a configuration and a luminous flux of the imaging lens in FIG. 1. FIGS. 1 and 2 show a state in which the imaging lens focuses on an infinite distance object. In FIGS. 1 and 2, a left side is an object side, and a right side is an image side. FIG. 2 shows, as the luminous flux, an on-axis luminous flux 2 and a luminous flux 3 of a maximum half angle of view ω. The examples shown in FIGS. 1 and 2 correspond to an imaging lens according to Example 1 described later. Hereinafter, the description will be made mainly with reference to FIG. 1.

The imaging lens according to the present disclosure consists of a first lens group G1 and a second lens group G2 in order from the object side to the image side along an optical axis Z. During focusing, the first lens group G1 moves along the optical axis Z, and the second lens group G2 is fixed with respect to an image plane Sim. In this way, by changing the spacing between the two groups having different degrees of separation between the on-axis luminous flux and the off-axis luminous flux, there is an advantage in suppressing fluctuation in aberration.

As an example, the imaging lens of FIG. 1 consists of, in order from the object side to the image side, a first lens group G1 having a positive refractive power and a second lens group G2 having a negative refractive power. In a case in which such a configuration is adopted, there is an advantage in the reduction in size.

As an example, each group of the imaging lens in FIG. 1 is formed as follows. The first lens group G1 consists of, in order from the object side to the image side, a front side partial group G1f, an aperture stop St, and a rear side partial group G1r. The front side partial group G1f consists of, in order from the object side to the image side, two lenses of lenses L11 and L12. The rear side partial group G1r consists of, in order from the object side to the image side, five lenses of lenses L13 to L17. The second lens group G2 consists of, in order from the object side to the image side, three lenses of lenses L21 to L23. It should be noted that the aperture stop St in FIG. 1 does not indicate a size or a shape and indicates a position in an optical axis direction. The parentheses and the leftward arrow below the first lens group G1 in FIG. 1 indicate that the first lens group G1 is a focusing group that moves during focusing and moves to the object side during focusing from the infinite distance object to the short range object.

In the imaging lens according to the present disclosure, the lens of the first lens group G1 closest to the object side is a negative lens. With this configuration, there is an advantage in the spherical aberration correction.

The object side surface of the negative lens of the first lens group G1 closest to the object side may be a concave surface. In a case in which such a configuration is adopted, there is an advantage in the spherical aberration correction.

In a case in which the first lens group G1 consists of, in order from the object side to the image side, the front side partial group G1f, the aperture stop St, and the rear side partial group G1r, the front side partial group G1f may consist of only a cemented lens in which a negative lens and a positive lens are cemented in order from the object side to the image side. In a case in which such a configuration is adopted, there is an advantage in the axial chromatic aberration and lateral chromatic aberration correction while achieving the reduction in size.

It is preferable that the first lens group G1 includes the cemented lens in which the negative lens and the positive lens are cemented on both the object side with respect to the aperture stop St and the image side with respect to the aperture stop St. In a case in which such a configuration is adopted, there is an advantage in the axial chromatic aberration and lateral chromatic aberration correction.

The first lens group G1 may include the aperture stop St and a single lens that is disposed adjacent to the to the image side of the aperture stop St and that has a positive refractive power. In a case in which such a configuration is adopted, there is an advantage in the spherical aberration and axial chromatic aberration correction while achieving the reduction in size. In addition, in a case in which the first lens group G1 includes the single lens that is disposed adjacent to the to the image side of the aperture stop St and that has a positive refractive power, it is preferable that the single lens has a biconvex shape. In a case in which such a configuration is adopted, there is an advantage in the reduction in size and the spherical aberration correction.

The single lens having a positive refractive power may be disposed on a side of the first lens group G1 closest to the image side, and the single lens having a negative refractive power may be disposed adjacent to the object side of the single lens. In a case in which such a configuration is adopted, there is an advantage in the lateral chromatic aberration correction.

It is preferable that a lens disposed on a side of the first lens group G1 closest to the image side is an aspherical lens having a positive refractive power. By disposing the positive lens on a side of the first lens group G1 closest to the image side, there is an advantage in the spherical aberration correction. In addition, on the side of the first lens group G1 closest to the image side, the on-axis luminous flux and the off-axis luminous flux in the vicinity of the screen are separated, and thus there is an advantage in the field curvature correction by disposing the aspherical lens here. Hereinafter, the aspherical lens having a positive refractive power, which is disposed on a side of the first lens group G1 closest to the image side, will be referred to as a first aspherical lens.

It is preferable that the first aspherical lens has the configuration described below. Hereafter, a height from the optical axis Z at a position of a maximum effective diameter on the image side surface of the first aspherical lens is denoted by hE1, an arbitrary height from the optical axis Z is denoted by h, and an amount of sag of each point on the image side surface of the first aspherical lens at the height h is denoted by Sg1(h). Sg1(h) is a function of h. It is preferable that, in a case in which a second derivative of Sg1(h) with respect to h is denoted by d²Sg1(h)/dh², the sign of d²Sg1(h)/dh² is constant in a range of 0<h≤hE1 on the image side surface of the first aspherical lens. In a case in which such a configuration is adopted, there is an advantage in the field curvature correction.

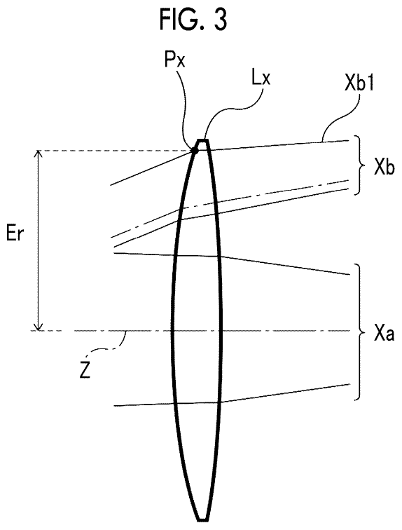

Here, the “position of the maximum effective diameter” in the present specification will be described with reference to FIG. 3. FIG. 3 is a diagram for description. In FIG. 3, a left side is the object side, and a right side is the image side. In FIG. 3, an on-axis luminous flux Xa and an off-axis luminous flux Xb that pass through a lens Lx are shown. In the example in FIG. 3, a ray Xb1 that is an upper ray in the off-axis luminous flux Xb is a ray passing through an outermost side. The term “outer side” herein means an outer side in a diameter direction centered on the optical axis Z, that is, a side away from the optical axis Z. A position of an intersection between the ray that passes through the outermost side and a lens surface is a position Px of the maximum effective diameter. It should be noted that a height from the optical axis Z at the position Px of the maximum effective diameter is an effective radius Er of the object side surface of the lens Lx. It should be noted that, while the ray on the upper side of the off-axis luminous flux Xb is the ray passing through the outermost side in the example in FIG. 3, which ray is the ray passing through the outermost side varies depending on the lens system.

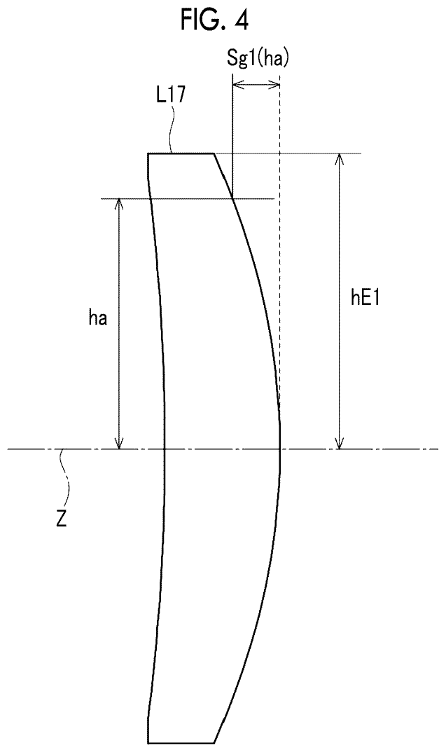

In addition, in the present specification, the “amount of sag” of each point on the surface at the height h is represented by a distance between a plane perpendicular to the optical axis Z passing through an intersection of the surface and the optical axis Z and each point on the surface at the height h. In the imaging lens shown in FIG. 1, the lens L17 corresponds to the first aspherical lens. FIG. 4 shows the lens L17 and shows the plane perpendicular to the optical axis Z passing through the intersection between the optical axis Z and the image side surface of the lens L17, by a broken line. In addition, as an example, FIG. 4 shows the height hE1 from the optical axis Z at the position of the maximum effective diameter, the height ha, and the amount of sag Sg1(ha) at the height ha on the image side surface of the lens L17.

The second lens group G2 may include only one positive lens. In a case in which such a configuration is adopted, there is an advantage in the reduction in size.

The lens of the second lens group G2 closest to the image side may be a positive lens. In a case in which such a configuration is adopted, there is an advantage in the reduction in size while reducing the incidence angle of the off-axis principal ray on the image plane Sim.

The second lens group G2 may consist of, in order from the object side to the image side, a negative lens, a negative lens, and a positive lens. In a case in which such a configuration is adopted, there is an advantage in the lateral chromatic aberration correction, and there is an advantage in the reduction in size while reducing the incidence angle of the off-axis principal ray on the image plane Sim.

The second lens group G2 may include an aspherical lens. In the second lens group G2, the on-axis luminous flux and the off-axis luminous flux in the vicinity of the screen are separated, and thus there is an advantage in the field curvature correction by disposing the aspherical lens in the second lens group G2. Hereafter the aspherical lens included in the second lens group G2 will be referred to as a second aspherical lens.

It is preferable that the second aspherical lens is disposed on a side of the second lens group G2 closest to the object side. In a case in which such a configuration is adopted, there is an advantage in terms of cost and for facilitating high-precision processing since the diameter of the aspherical lens can be reduced.

It is preferable that the second aspherical lens has the configuration described below. Hereafter, a height from the optical axis Z at a position of a maximum effective diameter on the image side surface of the second aspherical lens is denoted by hE2, an arbitrary height from the optical axis Z is denoted by h, and an amount of sag of each point on the image side surface of the second aspherical lens at the height h is denoted by Sg2(h). Sg2(h) is a function of h. It is preferable that, in a case in which the second derivative of Sg2(h) with respect to h is denoted by d²Sg2(h)/dh², a point that satisfies Conditional Expression (16) exists in a range of 0.5×hE2≤h≤hE2 on the image side surface of the second aspherical lens. In a case in which such a configuration is adopted, there is an advantage in the field curvature correction since it is possible to obtain an aspherical surface in which the amount of sag is large in the lens peripheral portion.

$$\vert {d}^{2} Sg 2 ( h ) / {dh}^{2} \vert > 2 \times \vert {d}^{2} Sg 2 ( h / 2 ) / {dh}^{2} \vert \qquad ( 16 )$$

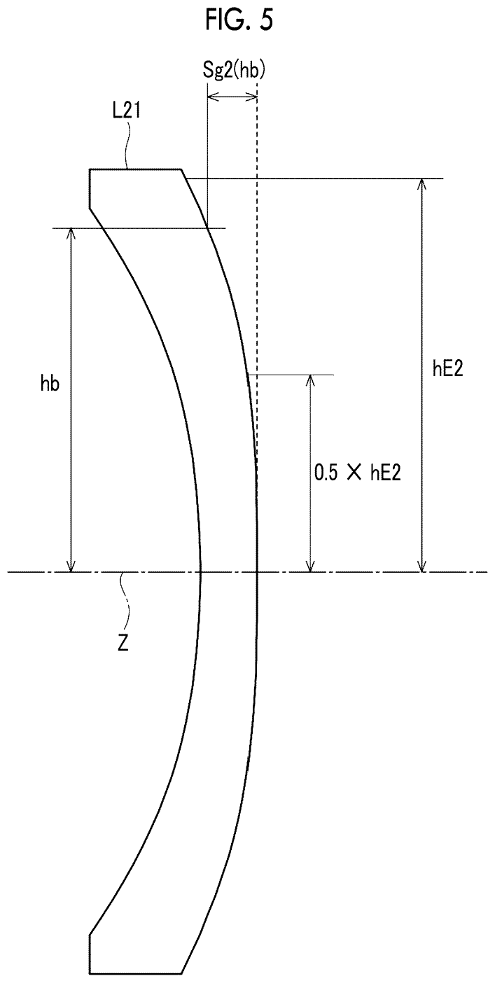

In the imaging lens shown in FIG. 1, the lens L21 corresponds to the second aspherical lens. FIG. 5 shows the lens L21 and shows the plane perpendicular to the optical axis Z passing through the intersection between the optical axis Z and the image side surface of the lens L21, by a broken line. In addition, as an example, FIG. 5 shows, on the image side surface of the lens L21, the height hE2 from the optical axis Z at the position of the maximum effective diameter, a height which is 0.5×hE2 from the optical axis Z, the height hb, and the amount of sag Sg2(hb) at the height hb.

It is preferable that the number of lenses included in the entire system is equal to or greater than 7 and equal to or less than 11. In such a case, it is easy to balance the reduction in size and the aberration correction. In order to obtain more favorable characteristics, it is preferable that the number of lenses included in the entire system is equal to or greater than 9 and equal to or less than 11.

It is preferable that the imaging lens according to the present disclosure satisfies at least one of Conditional Expressions described below. In the following description of the conditional expressions, in order to avoid redundancy, the same symbol will be used for the same definition, and the duplicate description of the symbol will be omitted. Hereinafter, the “imaging lens according to the present disclosure” will be simply referred to as the “imaging lens” in order to avoid redundancy.

It is preferable that the imaging lens satisfies Conditional Expression (1). Here, it is assumed that a sum of the back focus of the entire system in terms of the air conversion distance and a distance on the optical axis from a lens surface of the first lens group G1 closest to the object side to a lens surface of the second lens group G2 closest to the image side in a state in which the infinite distance object is in focus is TL. A focal length of the entire system in a state in which the infinite distance object is in focus is denoted by f. A maximum half angle of view in a state in which the infinite distance object is in focus is denoted by ω. TL is a optical total length in a state in which the infinite distance object is in focus. As an example, FIG. 2 shows the optical total length TL and the maximum half angle of view ω. By not allowing the corresponding values in Conditional Expression (1) to be equal to or less than the lower limit value thereof, there is an advantage in the spherical aberration and field curvature correction. By not allowing the corresponding values in Conditional Expression (1) to be equal to or greater than the upper limit value thereof, there is an advantage in the reduction in size.

$$1.3 < TL / ( f \times tan ω ) < 2.1 \qquad ( 1 )$$

In order to obtain more favorable characteristics, the lower limit value of Conditional Expression (1) is more preferably 1.37, still more preferably 1.44, still more preferably 1.51, still more preferably 1.58, and still more preferably 1.64. In order to obtain more favorable characteristics, the upper limit value of Conditional Expression (1) is more preferably 2.05, still more preferably 2, still more preferably 1.9, still more preferably 1.8, and still more preferably 1.72.

In a case in which a back focus of the entire system at the air conversion distance in a state in which the infinite distance object is in focus is denoted by Bf, it is preferable that the imaging lens satisfies Conditional Expression (2). The back focus at the air conversion distance is an air conversion distance on the optical axis from the lens surface of the imaging lens closest to the image side to the image plane Sim. As an example, FIG. 2 shows the back focus Bf. By not allowing the corresponding values in Conditional Expression (2) to be equal to or less than the lower limit value thereof, there is an advantage in ensuring the quantity of ambient light. By not allowing the corresponding values in Conditional Expression (2) to be equal to or greater than the upper limit value thereof, there is an advantage in the reduction in size.

$$0.08 < Bf / f < 0.3 \qquad ( 2 )$$

In order to obtain more favorable characteristics, the lower limit value of Conditional Expression (2) is more preferably 0.11, still more preferably 0.14, and still more preferably 0.17. In order to obtain more favorable characteristics, the upper limit value of Conditional Expression (2) is more preferably 0.27, still more preferably 0.24, and still more preferably 0.21.

In a case in which an open F-number in a state in which the infinite distance object is in focus is denoted by FNo, it is preferable that the imaging lens satisfies Conditional Expression (3). By not allowing the corresponding values in Conditional Expression (3) to be equal to or less than the lower limit value thereof, there is an advantage in various aberration corrections. By not allowing the corresponding values in Conditional Expression (3) to be equal to or greater than the upper limit value thereof, there is an advantage in achieving the reduction in total length while reducing the F number.

$$4.3 < FNo \times ( TL / f ) < 6.4 \qquad ( 3 )$$

In order to obtain more favorable characteristics, the lower limit value of Conditional Expression (3) is more preferably 4.8, still more preferably 5.2, and still more preferably 5.3. In order to obtain more favorable characteristics, the upper limit value of Conditional Expression (3) is more preferably 6.3, still more preferably 6.2, and still more preferably 6.1.

It is preferable that the imaging lens satisfies Conditional Expression (4). Here, a distance on the optical axis from a lens surface of the first lens group G1 closest to the object side to the lens surface of the first lens group G1 closest to the image side is denoted by dG1. As an example, FIG. 2 shows the distance dG1. By not allowing the corresponding values in Conditional Expression (4) to be equal to or less than the lower limit value thereof, there is an advantage in the spherical aberration correction. By not allowing the corresponding values in Conditional Expression (4) to be equal to or greater than the upper limit value thereof, there is an advantage in the reduction in size.

$$0. 45 < dG 1 / ( f \times tan ω ) < 1 \qquad ( 4 )$$

In order to obtain more favorable characteristics, the lower limit value of Conditional Expression (4) is more preferably 0.53, still more preferably 0.61, and still more preferably 0.7. In order to obtain more favorable characteristics, the upper limit value of Conditional Expression (4) is more preferably 0.9, still more preferably 0.85, and still more preferably 0.8.

It is preferable that the imaging lens satisfies Conditional Expression (5). Here, a distance on the optical axis from the lens surface of the first lens group G1 closest to the object side to the lens surface of the second lens group G2 closest to the image side in a state in which the infinite distance object is in focus is denoted by dF. As an example, FIG. 2 shows the distance dF. By not allowing the corresponding values in Conditional Expression (5) to be equal to or less than the lower limit value thereof, there is an advantage in the field curvature correction. By not allowing the corresponding values in Conditional Expression (5) to be equal to or greater than the upper limit value thereof, there is an advantage in the reduction in size.

$$0.05 < dF / ( f \times tan ω ) ) < 0 \text{.32} \qquad ( 5 )$$

In order to obtain more favorable characteristics, the lower limit value of Conditional Expression (5) is more preferably 0.1, still more preferably 0.15, and still more preferably 0.156. In order to obtain more favorable characteristics, the upper limit value of Conditional Expression (5) is more preferably 0.28, still more preferably 0.24, and still more preferably 0.2.

In the configuration in which the first lens group G1 consists of the front side partial group G1f, the aperture stop St, and the rear side partial group G1r in order from the object side to the image side, it is preferable that the imaging lens satisfies Conditional Expression (6). Here, a focal length of the front side partial group G1f is denoted by fG1f. A focal length of the first lens group G1 is denoted by fG1. By setting the corresponding values in Conditional Expression (6) within the range of Conditional Expression (6), there is an advantage in the spherical aberration correction.

$$1.8 < fG 1 f / fG 1 < 8 \qquad ( 6 )$$

In order to obtain more favorable characteristics, the lower limit value of Conditional Expression (6) is more preferably 2.1, still more preferably 2.5, and still more preferably 3.8. In order to obtain more favorable characteristics, the upper limit value of Conditional Expression (6) is more preferably 7, still more preferably 6, and still more preferably 5.3.

In the configuration in which the first lens group G1 consists of the front side partial group G1f, the aperture stop St, and the rear side partial group G1r in order from the object side to the image side, it is preferable that the imaging lens satisfies Conditional Expression (7). By setting the corresponding values in Conditional Expression (7) within the range of Conditional Expression (7), there is an advantage in the spherical aberration correction.

$$1.3 < fG 1 f / f < 5 \qquad ( 7 )$$

In order to obtain more favorable characteristics, the lower limit value of Conditional Expression (7) is more preferably 1.5, still more preferably 1.8, and still more preferably 2.5. In order to obtain more favorable characteristics, the upper limit value of Conditional Expression (7) is more preferably 4.2, still more preferably 3.4, and still more preferably 2.8.

In a case in which a focal length of the second lens group G2 is denoted by fG2, it is preferable that the imaging lens satisfies Conditional Expression (8). By not allowing the corresponding values in Conditional Expression (8) to be equal to or less than the lower limit value thereof, there is an advantage in the field curvature correction. By not allowing the corresponding values in Conditional Expression (8) to be equal to or greater than the upper limit value thereof, there is an advantage in the reduction in size.

$$- 2.5 < fG 2 / f < - 0.4 \qquad ( 8 )$$

In order to obtain more favorable characteristics, the lower limit value of Conditional Expression (8) is more preferably −2, still more preferably −1.5, and still more preferably −1.2.In order to obtain more favorable characteristics, the upper limit value of Conditional Expression (8) is more preferably −0.6, still more preferably −0.8, and still more preferably −0.85.

It is preferable that the imaging lens satisfies Conditional Expression (9). By not allowing the corresponding values in Conditional Expression (9) to be equal to or less than the lower limit value thereof, there is an advantage in the spherical aberration correction. By not allowing the corresponding values in Conditional Expression (9) to be equal to or greater than the upper limit value thereof, there is an advantage in the reduction in size.

$$0.4 < fG 1 / f < 0.95 \qquad ( 9 )$$

In order to obtain more favorable characteristics, the lower limit value of Conditional Expression (9) is more preferably 0.5, still more preferably 0.6, and still more preferably 0.62. In order to obtain more favorable characteristics, the upper limit value of Conditional Expression (9) is more preferably 0.8, still more preferably 0.7, and still more preferably 0.69.

It is preferable that the imaging lens satisfies Conditional Expression (10). Here, a lateral magnification of the first lens group G1 in a state in which the infinite distance object is in focus is denoted by ⊕G1. A lateral magnification of the second lens group G2 in a state in which the infinite distance object is in focus is denoted by βG2. By not allowing the corresponding value of Conditional Expression (10) to be equal to or less than the lower limit value, there is an advantage in the reduction in size. By not allowing the corresponding values in Conditional Expression (10) to be equal to or greater than the upper limit value thereof, there is an advantage in suppressing a change in optical performance in a case in which the subject distance is changed.

$$1. 4 < ( 1 - β G {1}^{2} ) \times β G {2}^{2} < 3.2 \qquad ( 10 )$$

In order to obtain more favorable characteristics, the lower limit value of Conditional Expression (10) is more preferably 1.7, still more preferably 2, and still more preferably 2.1. In order to obtain more favorable characteristics, the upper limit value of Conditional Expression (10) is more preferably 3, still more preferably 2.8, and still more preferably 2.6.

In the configuration in which the first lens group G1 consists of the front side partial group G1f, the aperture stop St, and the rear side partial group G1r in order from the object side to the image side, it is preferable that the imaging lens satisfies Conditional Expression (11). Here, an average value of refractive indexes of all the positive lenses included in the rear side partial group G1r at the d line is denoted by NG1rpa. By setting the corresponding values in Conditional Expression (11) within the range of Conditional Expression (11), there is an advantage in the spherical aberration correction.

$$1.6 < NG 1 rpa < 1.86 \qquad ( 11 )$$

In order to obtain more favorable characteristics, the lower limit value of Conditional Expression (11) is more preferably 1.65 and still more preferably 1.68. In order to obtain more favorable characteristics, the upper limit value of Conditional Expression (11) is more preferably 1.8 and still more preferably 1.75.

In the configuration in which the first lens group G1 consists of the front side partial group G1f, the aperture stop St, and the rear side partial group G1r in order from the object side to the image side, it is preferable that the imaging lens satisfies Conditional Expression (12). Here, an average value of Abbe numbers of all the positive lenses included in the rear side partial group G1r based on the d line is denoted by νG1rpa. An average value of the partial dispersion ratios of all the positive lenses included in the rear side partial group G1r between the g line and the F line is denoted by θG1rpa. By setting the corresponding values in Conditional Expression (12) within the range of Conditional Expression (12), there is an advantage in the axial chromatic aberration correction.

$$0.65 < θG 1 rpa + 0.0025 \times vG 1 rpa < 0.72 \qquad ( 12 )$$

In order to obtain more favorable characteristics, the lower limit value of Conditional Expression (12) is more preferably 0.665 and still more preferably 0.68. In order to obtain more favorable characteristics, the upper limit value of Conditional Expression (12) is more preferably 0.705 and still more preferably 0.695.

It should be noted that, in a case in which refractive indexes of a certain lens at a g line, an F line, and a C line are denoted by Ng, NF, and NC, respectively, and a partial dispersion ratio of the lens between the g line and the F line is denoted by θg,F, θg,F is defined as the following expression.

$$θ g , F = ( N g - NF ) / ( NF - N C )$$

In the configuration in which the first lens group G1 consists of, in order from the object side to the image side, the front side partial group G1f, the aperture stop St, and the rear side partial group G1r, it is preferable that the imaging lens satisfies Conditional Expressions (11) and (12) at the same time.

In the configuration in which only one positive lens is included in the second lens group G2, it is preferable that the imaging lens satisfies Conditional Expression (13). Here, a focal length of the positive lens in the second lens group G2 is denoted by fG2p. A focal length of the second lens group G2 is denoted by fG2. By not allowing the corresponding values in Conditional Expression (13) to be equal to or less than the lower limit value thereof, there is an advantage in the field curvature correction. By not allowing the corresponding values in Conditional Expression (13) to be equal to or greater than the upper limit value thereof, there is an advantage in correcting distortion.

$$- 4 < fG 2 p / fG 2 < - 1 \qquad ( 13 )$$

In order to obtain more favorable characteristics, the lower limit value of Conditional Expression (13) is more preferably −3.8, still more preferably −3.5, and still more preferably −3.2. In order to obtain more favorable characteristics, the upper limit value of Conditional Expression (13) is more preferably −1.25, still more preferably −1.5, and still more preferably −2.2.

In the configuration in which only one positive lens is included in the second lens group G2, it is preferable that the imaging lens satisfies Conditional Expression (14). Here, a refractive index of the positive lens in the second lens group G2 at the d line is denoted by NG2p. By setting the corresponding values in Conditional Expression (14) within the range of Conditional Expression (14), there is an advantage in the field curvature correction.

$$1.88 < NG 2 p < 1.96 \qquad ( 14 )$$

In order to obtain more favorable characteristics, the lower limit value of Conditional Expression (14) is more preferably 1.91 and still more preferably 1.92. In order to obtain more favorable characteristics, the upper limit value of Conditional Expression (14) is more preferably 1.93 and still more preferably 1.925.

In the configuration in which only one positive lens is included in the second lens group G2, it is preferable that the imaging lens satisfies Conditional Expression (15). Here, an Abbe number of the positive lens in the second lens group G2 based on the d line is denoted by νG2p. A partial dispersion ratio of the positive lens in the second lens group G2 between the g line and the F line is denoted by θG2p. By setting the corresponding values in Conditional Expression (15) within the range of Conditional Expression (15), there is an advantage in the lateral chromatic aberration correction.

$$0.67 < θ G 2 p + 0.0025 \times v G 2 p < 0.7 \; 05 \qquad ( 15 )$$

In order to obtain more favorable characteristics, the lower limit value of Conditional Expression (15) is more preferably 0.674 and still more preferably 0.678. In order to obtain more favorable characteristics, the upper limit value of Conditional Expression (15) is more preferably 0.695 and still more preferably 0.693.

In the configuration in which only one positive lens is included in the second lens group G2, it is preferable that the imaging lens satisfies Conditional Expressions (14) and (15) at the same time.

It is preferable that the imaging lens satisfies Conditional Expression (17). By not allowing the corresponding values in Conditional Expression (17) to be equal to or less than the lower limit value thereof, there is an advantage in various aberration corrections. By not allowing the corresponding values in Conditional Expression (17) to be equal to or greater than the upper limit value thereof, there is an advantage in the reduction in the total length.

$$1.2 < TL / f < 1.6 \qquad ( 17 )$$

In order to obtain more favorable characteristics, the lower limit value of Conditional Expression (17) is more preferably 1.3 and still more preferably 1.4. In order to obtain more favorable characteristics, the upper limit value of Conditional Expression (17) is more preferably 1.55 and still more preferably 1.5.

The preferred configurations and available configurations described above can be combined in any manner without inconsistency, and are selectively adopted as appropriate in accordance with required specifications.

As an example, in a preferred aspect of the imaging lens according to the present disclosure, the imaging lens consists of, in order from the object side to the image side, the first lens group G1 and the second lens group G2, in which, during focusing, the first lens group G1 moves along the optical axis Z, the second lens group G2 is fixed with respect to the image plane Sim, the lens of the first lens group G1 closest to the object side is a negative lens, and Conditional Expression (1) is satisfied.

Next, examples of the imaging lens according to the present disclosure will be described with reference to the drawings. It should be noted that reference numerals provided to the lens groups and the lenses in the cross-sectional view of each example are independently used for each example in order to avoid complication of description and the drawings caused by an increasing number of digits of the reference numerals. Accordingly, even in a case in which a common reference numeral is provided in the drawings of different examples, the common reference numeral does not always indicate a common configuration.

### Example 1

Since a cross-sectional view of the configuration of the imaging lens according to Example 1 is shown in FIG. 1, and its showing method and configuration are the same as described above, the duplicate descriptions will be partially omitted. The imaging lens according to Example 1 consists of, in order from the object side to the image side, a first lens group G1 that has a positive refractive power, and a second lens group G2 that has a negative refractive power. The first lens group G1 consists of, in order from the object side to the image side, a front side partial group G1f that has a positive refractive power, an aperture stop St, and a rear side partial group G1r that has a positive refractive power. During focusing on the short range object from the infinite distance object, the first lens group G1 moves to the object side along the optical axis Z, and the second lens group G2 is fixed with respect to the image plane Sim.

For the imaging lens according to Example 1, Table 1 shows basic lens data, Table 2 shows specification, and Table 3 shows aspherical coefficients thereof.

The table of the basic lens data is described as below. The column “Sn” indicates surface numbers in a case in which the number is increased by one at a time toward the image side from a surface closest to the object side as a first surface. The column “R” indicates a curvature radius of each surface. The column “D” indicates a surface spacing on the optical axis between each surface and its adjacent surface on the image side. The column “Nd” indicates a refractive index with respect to a d line for each lens. The column “νd” indicates an Abbe number based on the d line for each lens. The column “θg,F” indicates a partial dispersion ratio of each lens between the g line and the F line.

In the table of the basic lens data, a sign of a curvature radius of a surface having a convex shape facing the object side is positive, and a sign of a curvature radius of a surface having a convex shape facing the image side is negative. The field of a surface number of the surface corresponding to the aperture stop St has the term of the surface number (St). A value in the lowermost field of the column D in the table indicates a spacing between a surface closest to the image side in the table and the image plane Sim.

Table 2 shows the focal length f, the back focus Bf at the air conversion distance, the open F-number FNo, and the maximum full angle of view 2ω of the entire system, based on a d line. In the field of the maximum full angle of view, [°] indicates that the unit is degrees. The table of specifications shows values in a state in which the infinite distance object is in focus.

In the basic lens data, a surface number of an aspherical surface is marked with *, and a value of a paraxial curvature radius is shown in the field of the curvature radius of the aspherical surface. In Table 3, the line Sn shows the surface number of the aspherical surface, and the lines KA and Am show numerical values of the aspherical coefficients for each aspherical surface. It should be noted that m of Am is an integer equal to or greater than 3, and varies depending on the surface. For example, for the twelfth surface according to Example 1, m=4, 6, 8, 10, and 20. In Table 3, “E±n” (n: integer) of the numerical value of the aspherical coefficient means “×10^{±n}”. KA and Am are aspherical coefficients in an aspheric equation represented by the following equation.

$$Zd = C \times {h}^{2} / \{ 1 + {( 1 - KA \times {C}^{2} \times {h}^{2} )}^{1 / 2} \} + \sum Am \times {h}^{m}$$

Here,
Zd: aspherical surface depth (distance between the plane perpendicular to the optical axis Z, which passes through the intersection of the aspherical surface and the optical axis Z, and the point on the aspherical surface at the height h),
h: height (distance from optical axis Z to lens surface),
C: reciprocal of paraxial curvature radius, and
KA, Am: aspherical coefficients,
and Σ means the sum with respect to m in aspherical surface equation.

In the data of each table, degrees are used as a unit of angles, and a millimeter (mm) is used for a unit of lengths, but, since the optical system can also be proportionally enlarged or proportionally reduced to be used, other appropriate units can also be used. In addition, numerical values rounded to predetermined digits are described in each table shown below.

TABLE 1
Example 1

| Sn | R | D | Nd | νd | θg, F |
|---|---|---|---|---|---|
| 1 | −41.3697 | 0.7862 | 1.54814 | 45.78 | 0.56859 |
| 2 | 12.1072 | 1.9632 | 1.87070 | 40.73 | 0.56825 |
| 3 | 10546.4373 | 1.6001 | | | |
| 4(St) | ∞ | 2.4677 | | | |
| 5 | 39.8054 | 1.7030 | 1.75500 | 52.32 | 0.54757 |
| 6 | −39.8054 | 0.8251 | | | |
| 7 | −9.5360 | 0.5500 | 1.62004 | 36.26 | 0.58800 |
| 8 | 26.0290 | 3.6157 | 1.61997 | 63.88 | 0.54252 |
| 9 | −11.5956 | 0.0793 | | | |
| 10 | −32.9097 | 0.6001 | 1.56732 | 42.82 | 0.57309 |
| 11 | −139.7839 | 0.3222 | | | |
| *12 | −57.4364 | 2.6579 | 1.76802 | 49.24 | 0.55164 |
| *13 | −16.8228 | 4.7813 | | | |
| *14 | −23.3691 | 1.3130 | 1.68863 | 31.19 | 0.60069 |
| *15 | −105.0979 | 5.5773 | | | |
| 16 | −11.7612 | 0.9002 | 1.51633 | 64.14 | 0.53531 |
| 17 | −28.2741 | 1.5966 | | | |
| 18 | ∞ | 4.1906 | 1.92119 | 23.96 | 0.62025 |
| 19 | −65.5283 | 5.1540 | | | |

TABLE 2
Example 1

| | |
|---|---|
| f | 28.3822 |
| Bf | 5.1540 |
| FNo. | 4.12 |
| 2ω[°] | 81.4 |

TABLE 3
Example 1

| Sn | 12 | 13 | 14 |
|---|---|---|---|
| KA | 6.0133322992E−01 | 1.9767130238E+00 | 1.2955444772E+00 |
| A4 | −1.4127197631E−05 | 5.4786245846E−05 | −2.5418919949E−04 |
| A6 | −3.0334127157E−07 | −6.0796383022E−07 | 3.9912051438E−06 |
| A8 | 1.5768342279E−08 | 2.2859078257E−08 | −2.0508896128E−07 |
| A10 | −2.0899869447E−11 | −2.3095176282E−10 | 8.3881735400E−09 |
| A12 | −3.7830072223E−12 | 2.5515062548E−12 | −1.9633359527E−10 |
| A14 | 5.7969447297E−14 | −2.5261917331E−14 | 2.7179939851E−12 |
| A16 | −4.0496934717E−16 | 1.3103064246E−16 | −2.1958578596E−14 |
| A18 | 1.4029424278E−18 | −3.1862517929E−19 | 9.5564446862E−17 |
| A20 | −1.9395537554E−21 | 2.9299621562E−22 | −1.7293684215E−19 |

| Sn | 15 |
|---|---|
| KA | 6.2220556686E+00 |
| A3 | 0.0000000000E+00 |
| A4 | −2.1159639727E−04 |
| A5 | −4.5647787563E−05 |
| A6 | 1.4519703831E−05 |
| A7 | 9.4739381402E−07 |
| A8 | −9.4657680307E−07 |
| A9 | 6.4049905890E−08 |
| A10 | 2.7139414938E−08 |
| A11 | −3.6508534980E−09 |
| A12 | −3.5603400286E−10 |
| A13 | 7.7767918433E−11 |
| A14 | 1.3417947445E−12 |
| A15 | −8.3760100899E−13 |
| A16 | 1.5877725648E−14 |
| A17 | 4.5470957064E−15 |
| A18 | −1.7872381913E−16 |
| A19 | −9.8974348697E−18 |
| A20 | 5.1594562117E−19 |

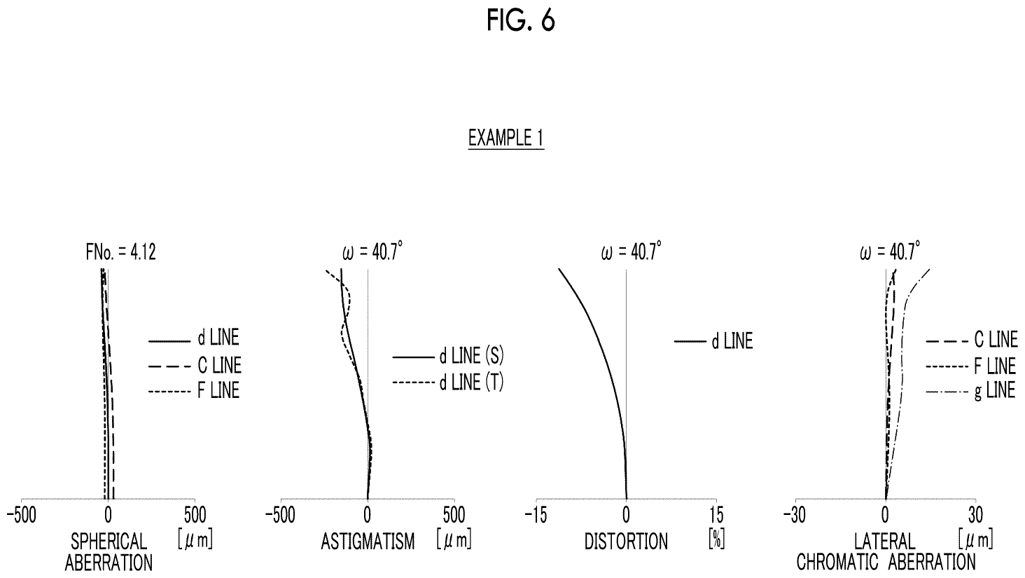

FIG. 6 shows aberration diagrams of the imaging lens according to Example 1 in a state in which the infinite distance object is in focus. In FIG. 6, the spherical aberration, the astigmatism, the distortion, and the lateral chromatic aberration are shown in this order from the left side. In the spherical aberration diagram, the aberrations at the d line, the C line, and the F line are shown by a solid line, a long broken line, and a short broken line, respectively. In the astigmatism diagram, the aberration at the d line in a sagittal direction is shown by a solid line, and the aberration at the d line in a tangential direction is shown by a short broken line. In the distortion diagram, the aberration at the d line is shown by a solid line. In the lateral chromatic aberration diagram, the aberrations at the C line, the F line, and the g line are shown by a long broken line, a short broken line, and a dot-dashed line, respectively. In the spherical aberration diagram, a value of the open F-number is shown after “FNo.=”. In other aberration diagrams, a value of the maximum half angle of view is shown after “ω=”.

Symbols, meanings, description methods, and showing methods of each data related to Example 1 are basically the same for the following examples unless otherwise noted, and thus the duplicate descriptions will be omitted below.

### Example 2

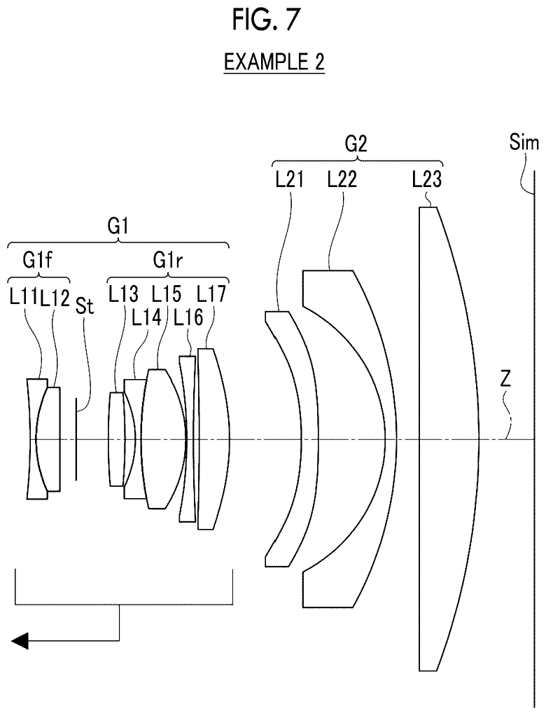

A cross-sectional view of a configuration of an imaging lens according to Example 2 is shown in FIG. 7. The imaging lens according to Example 2 consists of, in order from the object side to the image side, a first lens group G1 that has a positive refractive power, and a second lens group G2 that has a negative refractive power. The first lens group G1 consists of, in order from the object side to the image side, a front side partial group G1f that has a positive refractive power, an aperture stop St, and a rear side partial group G1r that has a positive refractive power. The front side partial group G1f consists of, in order from the object side to the image side, two lenses of lenses L11 and L12. The rear side partial group G1r consists of, in order from the object side to the image side, five lenses of lenses L13 to L17. The second lens group G2 consists of, in order from the object side to the image side, three lenses of the lenses L21 to L23. During focusing on the short range object from the infinite distance object, the first lens group G1 moves to the object side along the optical axis Z, and the second lens group G2 is fixed with respect to the image plane Sim.

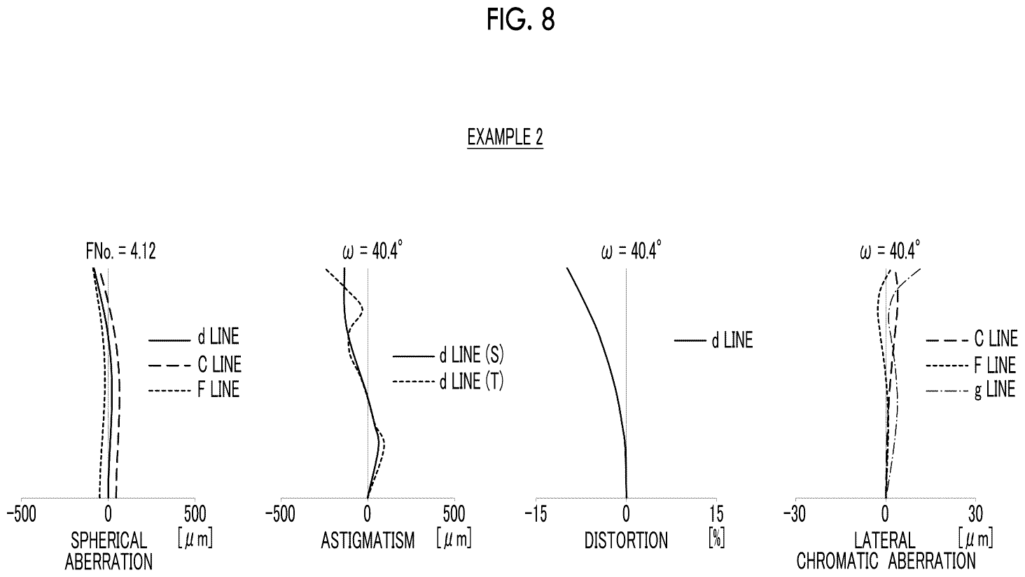

For the imaging lens according to Example 2, Table 4 shows basic lens data, Table 5 shows specification, and Table 6 shows aspherical coefficients thereof, and FIG. 8 shows aberration diagrams.

TABLE 4
Example 2

| Sn | R | D | Nd | νd | θg, F |
|---|---|---|---|---|---|
| 1 | −59.1021 | 0.5801 | 1.54814 | 45.78 | 0.56859 |
| 2 | 13.3460 | 2.3176 | 1.87070 | 40.73 | 0.56825 |
| 3 | ∞ | 1.6000 | | | |
| 4(St) | ∞ | 3.1418 | | | |
| 5 | 61.2164 | 1.6268 | 1.75500 | 52.32 | 0.54757 |
| 6 | −61.2164 | 1.0145 | | | |
| 7 | −11.4224 | 0.5500 | 1.62004 | 36.26 | 0.58800 |
| 8 | 33.8201 | 4.3772 | 1.61997 | 63.88 | 0.54252 |
| 9 | −13.4799 | 0.1002 | | | |
| 10 | −42.9680 | 0.6500 | 1.56732 | 42.82 | 0.57309 |
| 11 | 181.0143 | 0.5533 | | | |
| *12 | −445.1450 | 2.9669 | 1.76802 | 49.24 | 0.55164 |
| *13 | −25.3426 | 6.9659 | | | |
| *14 | −31.9220 | 1.6600 | 1.68863 | 31.19 | 0.60069 |
| *15 | −97.1293 | 6.5408 | | | |
| 16 | −15.4470 | 1.0999 | 1.56384 | 60.71 | 0.54120 |
| 17 | −36.6821 | 2.2323 | | | |
| 18 | ∞ | 5.8154 | 1.92119 | 23.96 | 0.62025 |
| 19 | −69.8337 | 5.4299 | | | |

TABLE 5
Example 2

| | |
|---|---|
| f | 35.6183 |
| Bf | 5.4299 |
| FNo. | 4.12 |
| 2ω[°] | 80.8 |

TABLE 6
Example 2

| Sn | 12 | 13 | 14 |
|---|---|---|---|
| KA | −1.5012856558E−07 | 1.8786267073E+00 | −7.2618651809E−06 |
| A4 | −2.2820984376E−05 | 1.3374223916E−05 | −1.4184416083E−04 |
| A6 | 5.2850239541E−07 | 6.9414266774E−08 | 1.7604381505E−06 |
| A8 | −1.1465210770E−08 | 1.4296305652E−09 | −4.5157707131E−08 |
| A10 | 1.9309914373E−10 | −5.2375735795E−12 | 9.7552252627E−10 |
| A12 | −1.8799962721E−12 | 5.1890423414E−14 | −1.3398984823E−11 |
| A14 | 1.0624789728E−14 | −5.4589871493E−16 | 1.1429361705E−13 |
| A16 | −3.5101284672E−17 | 2.0815025877E−18 | −5.8031217240E−16 |
| A18 | 6.3071730293E−20 | −3.3251052129E−21 | 1.5986439226E−18 |
| A20 | −4.7671770610E−23 | 1.9292336115E−24 | −1.8350393114E−21 |

| Sn | 15 |
|---|---|
| KA | 9.5618894166E+00 |
| A3 | −2.0844283154E−19 |
| A4 | −8.9871571632E−05 |
| A5 | −2.6015251216E−05 |
| A6 | 4.5233991923E−06 |
| A7 | 5.7627708891E−07 |
| A8 | −1.9557224472E−07 |
| A9 | 1.5899334684E−09 |
| A10 | 3.6959938688E−09 |
| A11 | −2.2945475212E−10 |
| A12 | −3.4127826949E−11 |
| A13 | 3.5595358270E−12 |
| A14 | 1.3673825931E−13 |
| A15 | −2.5283845942E−14 |
| A16 | 3.4800602097E−17 |
| A17 | 8.7851367332E−17 |
| A18 | −1.9145595246E−18 |
| A19 | −1.2082049332E−19 |
| A20 | 4.1166046688E−21 |

### Example 3

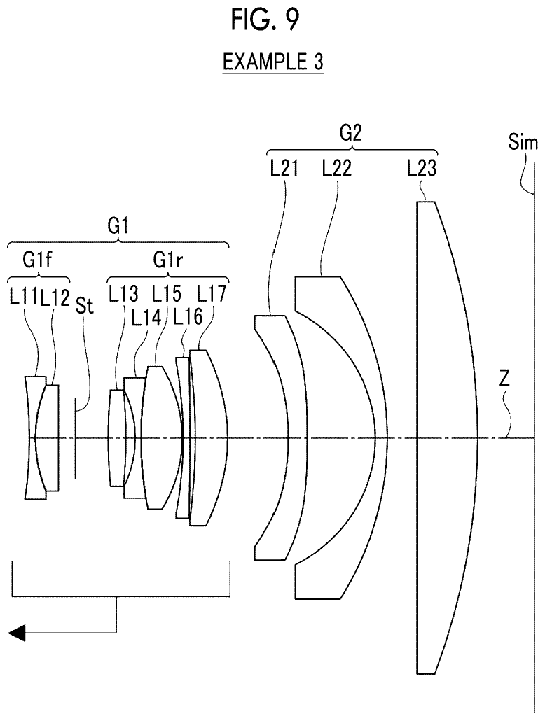

A cross-sectional view of a configuration of an imaging lens according to Example 3 is shown in FIG. 9. The imaging lens according to Example 3 consists of, in order from the object side to the image side, a first lens group G1 that has a positive refractive power, and a second lens group G2 that has a negative refractive power. The first lens group G1 consists of, in order from the object side to the image side, a front side partial group G1f that has a positive refractive power, an aperture stop St, and a rear side partial group G1r that has a positive refractive power. The front side partial group G1f consists of, in order from the object side to the image side, two lenses of lenses L11 and L12. The rear side partial group G1r consists of, in order from the object side to the image side, five lenses of lenses L13 to L17. The second lens group G2 consists of, in order from the object side to the image side, three lenses of the lenses L21 to L23. During focusing on the short range object from the infinite distance object, the first lens group G1 moves to the object side along the optical axis Z, and the second lens group G2 is fixed with respect to the image plane Sim.

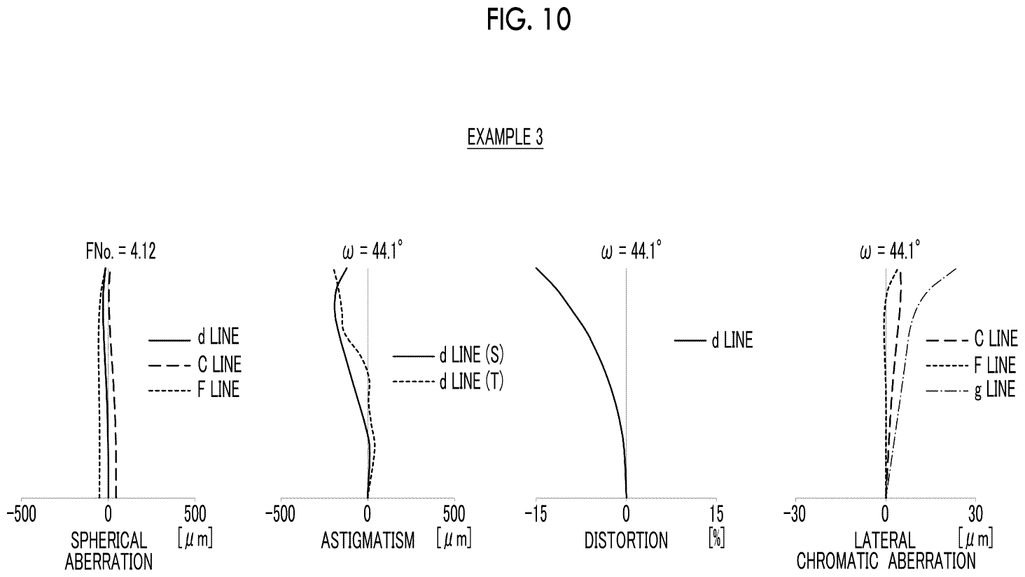

For the imaging lens according to Example 3, Table 7 shows basic lens data, Table 8 shows specifications and a variable surface spacing, Table 9 shows an aspherical coefficient, and FIG. 10 shows each aberration diagram.

TABLE 7
Example 3

| Sn | R | D | Nd | νd | θg, F |
|---|---|---|---|---|---|
| 1 | −45.0983 | 0.5799 | 1.58144 | 40.75 | 0.57757 |
| 2 | 14.4057 | 2.1808 | 1.90043 | 37.37 | 0.57668 |
| 3 | ∞ | 1.6000 | | | |
| 4(St) | ∞ | 3.1386 | | | |
| 5 | 50.0307 | 1.6842 | 1.90043 | 37.37 | 0.57668 |
| 6 | −50.0307 | 0.8868 | | | |
| 7 | −11.4694 | 0.5502 | 1.62004 | 36.26 | 0.58800 |
| 8 | 38.0315 | 3.9132 | 1.61997 | 63.88 | 0.54252 |
| 9 | −14.0725 | 0.1001 | | | |
| 10 | −41.9242 | 0.6502 | 1.84666 | 23.78 | 0.61923 |
| 11 | −356.3924 | 0.5006 | | | |
| *12 | −65.9471 | 3.0724 | 1.85060 | 41.62 | 0.56454 |
| *13 | −18.8380 | 5.7106 | | | |
| *14 | −28.4986 | 1.8077 | 1.68863 | 31.19 | 0.60069 |
| *15 | −139.4396 | 6.4741 | | | |
| 16 | −14.2820 | 1.1471 | 1.51742 | 52.43 | 0.55649 |
| 17 | −30.9330 | 2.8388 | | | |
| 18 | ∞ | 5.7479 | 1.92119 | 23.96 | 0.62025 |
| 19 | −69.8703 | 5.4010 | | | |

TABLE 8
Example 3

| | |
|---|---|
| f | 33.1962 |
| Bf | 5.4010 |
| FNo. | 4.12 |
| 2ω[°] | 88.2 |

TABLE 9
Example 3

| Sn | 12 | 13 | 14 |
|---|---|---|---|
| KA | 1.8327911633E−01 | 1.5072564536E+00 | 1.4855581685E+00 |
| A4 | −7.2292972447E−06 | 2.6735433619E−05 | −1.2574381160E−04 |
| A6 | −1.0566417655E−07 | −1.8278438730E−07 | 1.2398761887E−06 |
| A8 | 3.5148364033E−09 | 4.4128291213E−09 | −4.0143289316E−08 |
| A10 | −9.0819774170E−12 | −2.8128293101E−11 | 1.0277509031E−09 |
| A12 | −2.3687536267E−13 | 1.9462610688E−13 | −1.5032344787E−11 |
| A14 | 2.5303116335E−15 | −1.2014121435E−15 | 1.3000536434E−13 |
| A16 | −1.1480588228E−17 | 3.8906266051E−18 | −6.5624789563E−16 |
| A18 | 2.5402912573E−20 | −5.9120032004E−21 | 1.7849637469E−18 |
| A20 | −2.2274653352E−23 | 3.3985365286E−24 | −2.0193232148E−21 |

| Sn | 15 |
|---|---|
| KA | 3.1996889063E+00 |
| A3 | 7.0040589752E−20 |
| A4 | −1.0357466876E−04 |
| A5 | −1.8159056762E−05 |
| A6 | 4.4141604565E−06 |
| A7 | 2.4638530977E−07 |
| A8 | −1.8062782119E−07 |
| A9 | 9.4489224908E−09 |
| A10 | 3.2367515214E−09 |
| A11 | −3.4468883699E−10 |
| A12 | −2.6382583223E−11 |
| A13 | 4.6186739553E−12 |
| A14 | 5.9182291089E−14 |
| A15 | −3.1200020003E−14 |
| A16 | 4.9106626263E−16 |
| A17 | 1.0612171836E−16 |
| A18 | −3.3677231069E−18 |
| A19 | −1.4465619593E−19 |
| A20 | 6.0459937107E−21 |

### Example 4

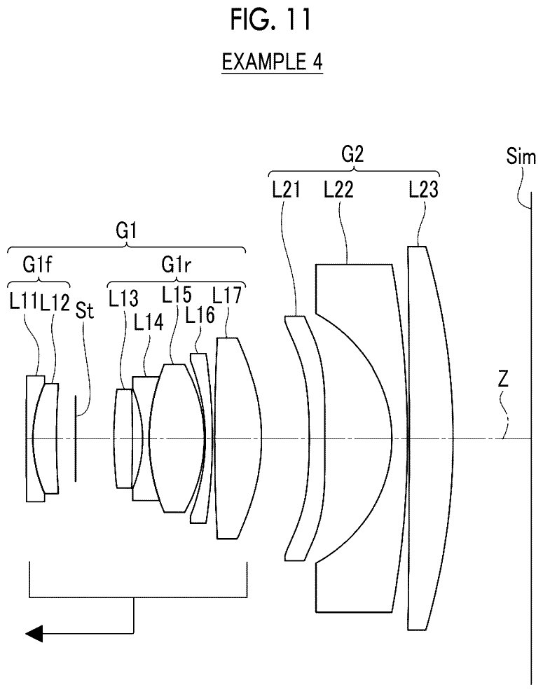

A cross-sectional view of a configuration of an imaging lens according to Example 4 is shown in FIG. 11. The imaging lens according to Example 4 consists of, in order from the object side to the image side, a first lens group G1 that has a positive refractive power, and a second lens group G2 that has a negative refractive power. The first lens group G1 consists of, in order from the object side to the image side, a front side partial group G1f that has a positive refractive power, an aperture stop St, and a rear side partial group G1r that has a positive refractive power. The front side partial group G1f consists of, in order from the object side to the image side, two lenses of lenses L11 and L12. The rear side partial group G1r consists of, in order from the object side to the image side, five lenses of lenses L13 to L17. The second lens group G2 consists of, in order from the object side to the image side, three lenses of the lenses L21 to L23. During focusing on the short range object from the infinite distance object, the first lens group G1 moves to the object side along the optical axis Z, and the second lens group G2 is fixed with respect to the image plane Sim.

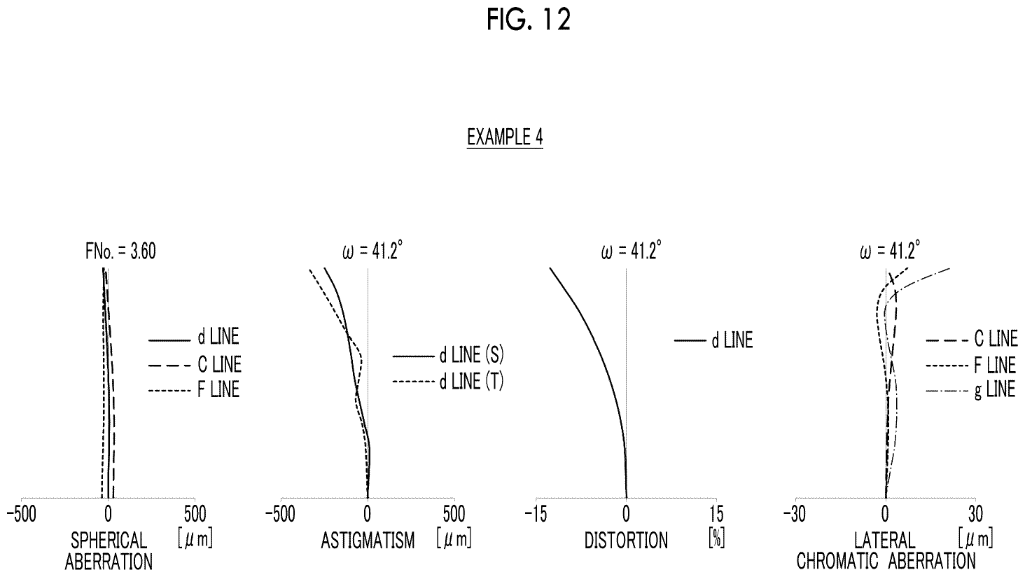

For the imaging lens according to Example 4, Table 10 shows basic lens data, Table 11 shows specifications and a variable surface spacing, Table 12 shows an aspherical coefficient, and FIG. 12 shows each aberration diagram.

TABLE 10
Example 4

| Sn | R | D | Nd | νd | θg, F |
|---|---|---|---|---|---|
| 1 | 771.2479 | 0.5598 | 1.59551 | 39.24 | 0.58043 |
| 2 | 12.3944 | 1.9775 | 1.91082 | 35.25 | 0.58335 |
| 3 | 67.4818 | 1.6092 | | | |
| 4(St) | ∞ | 3.2335 | | | |
| 5 | 37.4976 | 1.5613 | 1.87070 | 40.73 | 0.56825 |
| 6 | −144.5929 | 0.8563 | | | |
| 7 | −12.0991 | 0.5498 | 1.62004 | 36.26 | 0.58800 |
| 8 | 17.2199 | 4.6448 | 1.59282 | 68.62 | 0.54414 |
| 9 | −13.5456 | 0.0792 | | | |
| 10 | −19.3541 | 0.5998 | 1.60342 | 38.03 | 0.58356 |
| 11 | −52.1209 | 0.1998 | | | |
| *12 | 189.4415 | 3.9469 | 1.72903 | 54.04 | 0.54474 |
| *13 | −17.9734 | 3.9665 | | | |
| *14 | −54.3625 | 1.3130 | 1.68863 | 31.19 | 0.60069 |
| *15 | 1587.5705 | 5.6429 | | | |
| 16 | −12.6349 | 1.3110 | 1.53172 | 48.84 | 0.56309 |
| 17 | −89.6714 | 0.1540 | | | |
| 18 | −1278.7934 | 3.6900 | 1.92286 | 20.88 | 0.63900 |
| 19 | −63.1221 | 6.5825 | | | |

TABLE 11
Example 4

| | |
|---|---|
| f | 28.3541 |
| Bf | 6.5825 |
| FNo. | 3.60 |
| 2ω[°] | 82.4 |

TABLE 12
Example 4

| Sn | 12 | 13 | 14 |
|---|---|---|---|
| KA | 9.9472603096E+00 | 1.9392439418E+00 | 1.3970505614E+00 |
| A4 | 1.3101517488E−05 | 9.4123626690E−05 | −1.6337313789E−05 |
| A6 | −1.0489687332E−06 | −1.9549579245E−06 | −8.2066625561E−06 |
| A8 | 2.5958076110E−08 | 5.1307236208E−08 | 2.1943876002E−07 |
| A10 | −2.0715841335E−10 | −8.0842770023E−10 | −2.8253643146E−09 |
| A12 | −4.2371291309E−13 | 9.7640882141E−12 | 1.1959860101E−11 |
| A14 | 2.1800940839E−14 | −7.4928957957E−14 | 1.6453092987E−13 |
| A16 | −1.8415067713E−16 | 3.1946834741E−16 | −2.6489688263E−15 |
| A18 | 6.7522646344E−19 | −6.9060408850E−19 | 1.4874114511E−17 |
| A20 | −9.2693073392E−22 | 5.9247896496E−22 | −3.1279702226E−20 |

| Sn | 15 |
|---|---|
| KA | −9.0000000004E−06 |
| A3 | 0.0000000000E+00 |
| A4 | 1.5099336281E−05 |
| A5 | −6.2088186166E−05 |
| A6 | 5.3281292815E−06 |
| A7 | 1.5896671659E−06 |
| A8 | −6.0922835746E−07 |
| A9 | 2.2376396002E−08 |
| A10 | 1.9209090363E−08 |
| A11 | −2.0180009246E−09 |
| A12 | −2.7419066668E−10 |
| A13 | 4.4054788697E−11 |
| A14 | 1.5896303719E−12 |
| A15 | −4.6348395473E−13 |
| A16 | 2.4124223828E−15 |
| A17 | 2.4252438089E−15 |
| A18 | −6.7498687467E−17 |
| A19 | −5.0617713701E−18 |
| A20 | 2.1272233119E−19 |

### Example 5

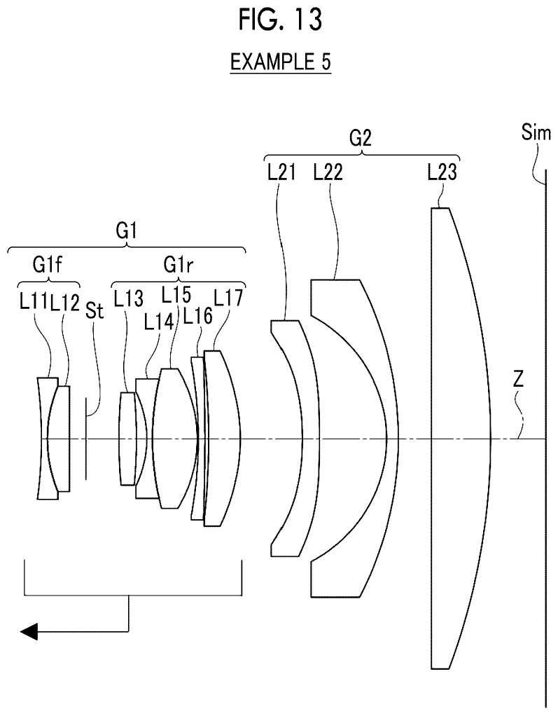

A cross-sectional view of a configuration of an imaging lens according to Example 5 is shown in FIG. 13. The imaging lens according to Example 5 consists of, in order from the object side to the image side, a first lens group G1 that has a positive refractive power, and a second lens group G2 that has a negative refractive power. The first lens group G1 consists of, in order from the object side to the image side, a front side partial group G1f that has a positive refractive power, an aperture stop St, and a rear side partial group G1r that has a positive refractive power. The front side partial group G1f consists of, in order from the object side to the image side, two lenses of lenses L11 and L12. The rear side partial group G1r consists of, in order from the object side to the image side, five lenses of lenses L13 to L17. The second lens group G2 consists of, in order from the object side to the image side, three lenses of the lenses L21 to L23. During focusing on the short range object from the infinite distance object, the first lens group G1 moves to the object side along the optical axis Z, and the second lens group G2 is fixed with respect to the image plane Sim.

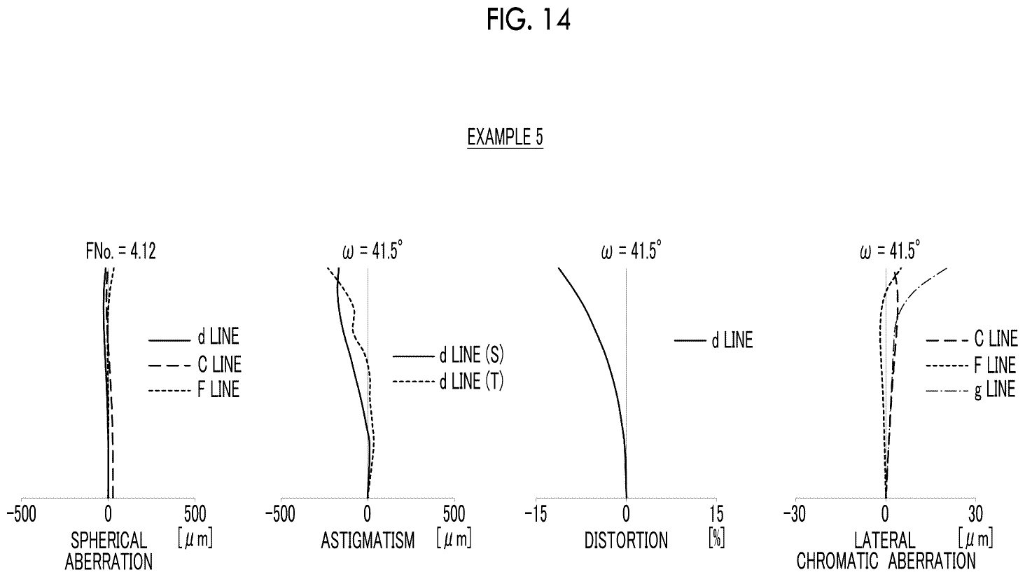

For the imaging lens according to Example 5 Table 13 shows basic lens data, Table 14 shows specifications and a variable surface spacing, Table 15 shows an aspherical coefficient, and FIG. 14 shows each aberration diagram.

TABLE 13
Example 5

| Sn | R | D | Nd | νd | θg, F |
|---|---|---|---|---|---|
| 1 | −50.3724 | 0.5800 | 1.54814 | 45.78 | 0.56859 |
| 2 | 14.6617 | 2.1600 | 1.87070 | 40.73 | 0.56825 |
| 3 | ∞ | 1.6000 | | | |
| 4(St) | ∞ | 3.2100 | | | |
| 5 | 51.9089 | 1.7100 | 1.75500 | 52.32 | 0.54757 |
| 6 | −51.9089 | 1.0124 | | | |
| 7 | −11.4182 | 0.5500 | 1.62004 | 36.26 | 0.58800 |
| 8 | 28.7482 | 4.3700 | 1.61997 | 63.88 | 0.54252 |
| 9 | −14.2170 | 0.1000 | | | |
| 10 | −45.1189 | 0.6400 | 1.56732 | 42.82 | 0.57309 |
| 11 | −251.9504 | 0.3663 | | | |
| *12 | −83.7111 | 3.0800 | 1.76802 | 49.24 | 0.55164 |
| *13 | −20.4535 | 6.0000 | | | |
| *14 | −30.1885 | 1.6600 | 1.68863 | 31.19 | 0.60069 |
| *15 | −137.7142 | 6.5500 | | | |
| 16 | −14.3492 | 1.1400 | 1.51633 | 64.14 | 0.53531 |
| 17 | −36.5121 | 3.2300 | | | |
| 18 | ∞ | 5.7600 | 1.92119 | 23.96 | 0.62025 |
| 19 | −69.9242 | 5.3962 | | | |

TABLE 14
Example 5

| | |
|---|---|
| f | 34.8463 |
| Bf | 5.3962 |
| FNo. | 4.12 |
| 2ω[°] | 83.0 |

TABLE 15
Example 5

| Sn | 12 | 13 | 14 |
|---|---|---|---|
| KA | 3.1024553941E+00 | 1.8414798937E+00 | 1.5386343333E+00 |
| A4 | −7.0023045429E−06 | 2.6535069872E−05 | −1.2557231818E−04 |
| A6 | −9.4753226086E−08 | −1.7876968415E−07 | 1.2241585705E−06 |
| A8 | 3.1001699495E−09 | 4.3566170495E−09 | −3.9408797975E−08 |
| A10 | −3.4374049665E−12 | −2.7653832283E−11 | 1.0117637781E−09 |
| A12 | −2.7796877419E−13 | 1.9196600442E−13 | −1.4844491690E−11 |
| A14 | 2.7035420141E−15 | −1.1912570741E−15 | 1.2872743002E−13 |
| A16 | −1.1894030479E−17 | 3.8662215401E−18 | −6.5119887653E−16 |
| A18 | 2.5901002226E−20 | −5.8797851965E−21 | 1.7741841901E−18 |
| A20 | −2.2489114855E−23 | 3.3809801750E−24 | −2.0096774496E−21 |

| Sn | 15 |
|---|---|
| KA | 7.0896629652E+00 |
| A3 | 0.0000000000E+00 |
| A4 | −1.0499566787E−04 |
| A5 | −1.7524859132E−05 |
| A6 | 4.5030349598E−06 |
| A7 | 2.1858635689E−07 |
| A8 | −1.8332704424E−07 |
| A9 | 1.0104186656E−08 |
| A10 | 3.2832007849E−09 |
| A11 | −3.5373721277E−10 |
| A12 | −2.6860875467E−11 |
| A13 | 4.6941325681E−12 |
| A14 | 6.2135840221E−14 |
| A15 | −3.1574129484E−14 |
| A16 | 4.8063364846E−16 |
| A17 | 1.0713713899E−16 |
| A18 | −3.3492681519E−18 |
| A19 | −1.4581851029E−19 |
| A20 | 6.0349230674E−21 |

### Example 6

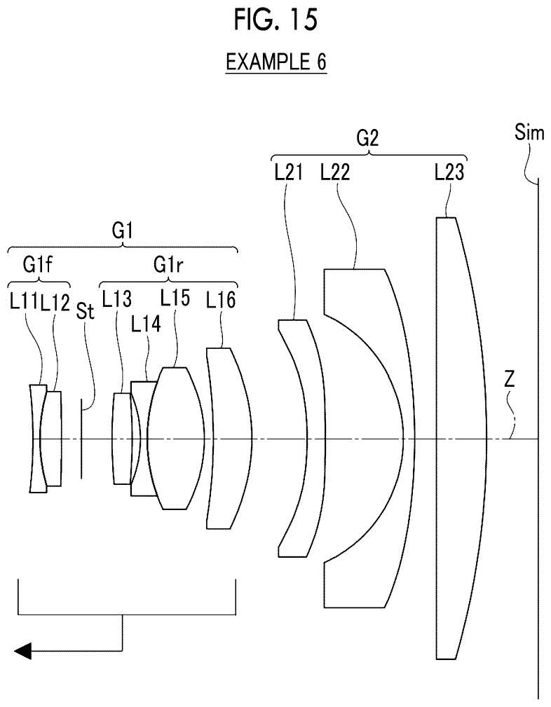

A cross-sectional view of a configuration of an imaging lens according to Example 6 is shown in FIG. 15. The imaging lens according to Example 6 consists of, in order from the object side to the image side, a first lens group G1 that has a positive refractive power, and a second lens group G2 that has a negative refractive power. The first lens group G1 consists of, in order from the object side to the image side, a front side partial group G1f that has a positive refractive power, an aperture stop St, and a rear side partial group G1r that has a positive refractive power. The front side partial group G1f consists of, in order from the object side to the image side, two lenses of lenses L11 and L12. The rear side partial group G1r consists of, in order from the object side to the image side, four lenses of lenses L13 to L16. The second lens group G2 consists of, in order from the object side to the image side, three lenses of the lenses L21 to L23. During focusing on the short range object from the infinite distance object, the first lens group G1 moves to the object side along the optical axis Z, and the second lens group G2 is fixed with respect to the image plane Sim.

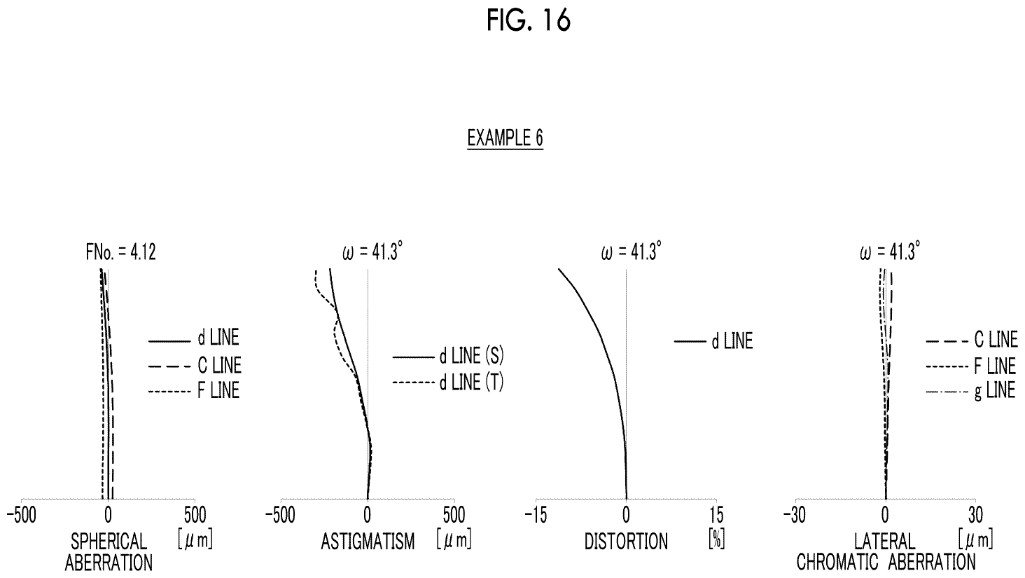

For the imaging lens according to Example 6, Table 16 shows basic lens data, Table 17 shows specifications and a variable surface spacing, Table 18 shows an aspherical coefficient, and FIG. 16 shows each aberration diagram.

TABLE 16
Example 6

| Sn | R | D | Nd | νd | θg, F |
|---|---|---|---|---|---|
| 1 | −40.2118 | 0.5601 | 1.54814 | 45.78 | 0.56859 |
| 2 | 14.8376 | 1.7067 | 1.87070 | 40.73 | 0.56825 |
| 3 | −159.6566 | 1.6001 | | | |
| 4(St) | ∞ | 2.4304 | | | |
| 5 | 42.0584 | 1.6008 | 1.72916 | 54.67 | 0.54534 |
| 6 | −42.0584 | 0.6502 | | | |
| 7 | −10.2379 | 0.5500 | 1.62205 | 41.08 | 0.56917 |
| 8 | 14.5148 | 4.5456 | 1.59282 | 68.62 | 0.54414 |
| 9 | −12.5661 | 0.7050 | | | |
| *10 | −46.3741 | 3.0710 | 1.73050 | 53.94 | 0.54560 |
| *11 | −16.3703 | 4.3504 | | | |
| *12 | −27.7431 | 1.4430 | 1.68863 | 31.19 | 0.60069 |
| *13 | −298.5465 | 6.2208 | | | |
| *14 | −12.1300 | 0.9000 | 1.51633 | 64.06 | 0.53378 |
| *15 | −52.6948 | 1.7412 | | | |
| 16 | ∞ | 3.9841 | 1.92119 | 23.96 | 0.62025 |
| 17 | −69.4677 | 4.1048 | | | |

TABLE 17
Example 6

| | |
|---|---|
| f | 27.7665 |
| Bf | 4.1048 |
| FNo. | 4.12 |
| 2ω[°] | 84.8 |

TABLE 18
Example 6

| Sn | 10 | 11 | 12 |
|---|---|---|---|
| KA | 1.5804560059E+00 | 1.8928278663E+00 | 3.0920254825E−02 |
| A4 | −1.4136681472E−05 | 5.4827644316E−05 | −2.5253867284E−04 |
| A6 | −3.0348074338E−07 | −6.0606672733E−07 | 4.0333220660E−06 |
| A8 | 1.5774996800E−08 | 2.2679265931E−08 | −2.0444022101E−07 |
| A10 | −2.0908814894E−11 | −2.3107911574E−10 | 8.3881821307E−09 |
| A12 | −3.7830141998E−12 | 2.5521549509E−12 | −1.9633359364E−10 |
| A14 | 5.7969432677E−14 | −2.5261504732E−14 | 2.7179941995E−12 |
| A16 | −4.0496906573E−16 | 1.3103063498E−16 | −2.1958577833E−14 |
| A18 | 1.4029420126E−18 | −3.1862515602E−19 | 9.5564446912E−17 |
| A20 | −1.9395537516E−21 | 2.9299616625E−22 | −1.7293684209E−19 |

| Sn | 13 |
|---|---|
| KA | 7.1875973653E+00 |
| A3 | 1.5993390581E−08 |
| A4 | −2.1159152608E−04 |
| A5 | −4.5664811540E−05 |
| A6 | 1.4518953375E−05 |
| A7 | 9.4738503545E−07 |
| A8 | −9.4658666116E−07 |
| A9 | 6.4049761077E−08 |
| A10 | 2.7139410542E−08 |
| A11 | −3.6508559623E−09 |
| A12 | −3.5603397482E−10 |
| A13 | 7.7767918567E−11 |
| A14 | 1.3417950055E−12 |
| A15 | −8.3760100964E−13 |
| A16 | 1.5877725624E−14 |
| A17 | 4.5470955967E−15 |
| A18 | −1.7872381908E−16 |
| A19 | −9.8974348736E−18 |
| A20 | 5.1594562120E−19 |

| Sn | 14 | 15 |
|---|---|---|
| KA | 1.1844911372E+00 | 9.9656235082E+00 |
| A4 | 4.1006242197E−07 | 1.2556581240E−07 |
| A6 | 3.7706040115E−08 | 7.3473658299E−10 |
| A8 | 1.3499285345E−10 | 2.5089747712E−12 |
| A10 | 3.3361500741E−13 | 2.1580715360E−14 |
| A12 | 5.4662067987E−15 | 3.3115202956E−17 |
| A14 | 1.2943326139E−17 | 8.4080410992E−19 |
| A16 | 1.7280470801E−19 | −2.1269103113E−23 |
| A18 | 8.8974033145E−21 | 2.1543603174E−23 |
| A20 | 9.7868275593E−23 | 3.3866472201E−26 |

### Example 7

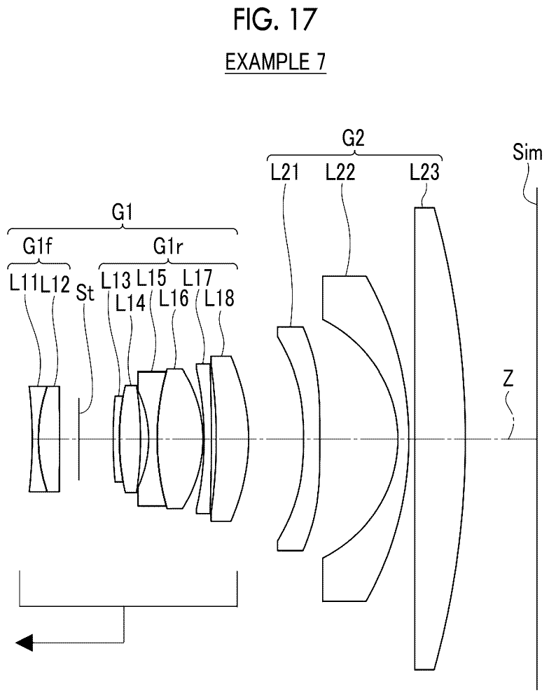

A cross-sectional view of a configuration of an imaging lens according to Example 7 is shown in FIG. 17. The imaging lens according to Example 7 consists of, in order from the object side to the image side, a first lens group G1 that has a positive refractive power, and a second lens group G2 that has a negative refractive power. The first lens group G1 consists of, in order from the object side to the image side, a front side partial group G1f that has a positive refractive power, an aperture stop St, and a rear side partial group G1r that has a positive refractive power. The front side partial group G1f consists of, in order from the object side to the image side, two lenses of lenses L11 and L12. The rear side partial group G1r consists of, in order from the object side to the image side, six lenses of lenses L13 to L18. The second lens group G2 consists of, in order from the object side to the image side, three lenses of the lenses L21 to L23. During focusing on the short range object from the infinite distance object, the first lens group G1 moves to the object side along the optical axis Z, and the second lens group G2 is fixed with respect to the image plane Sim.

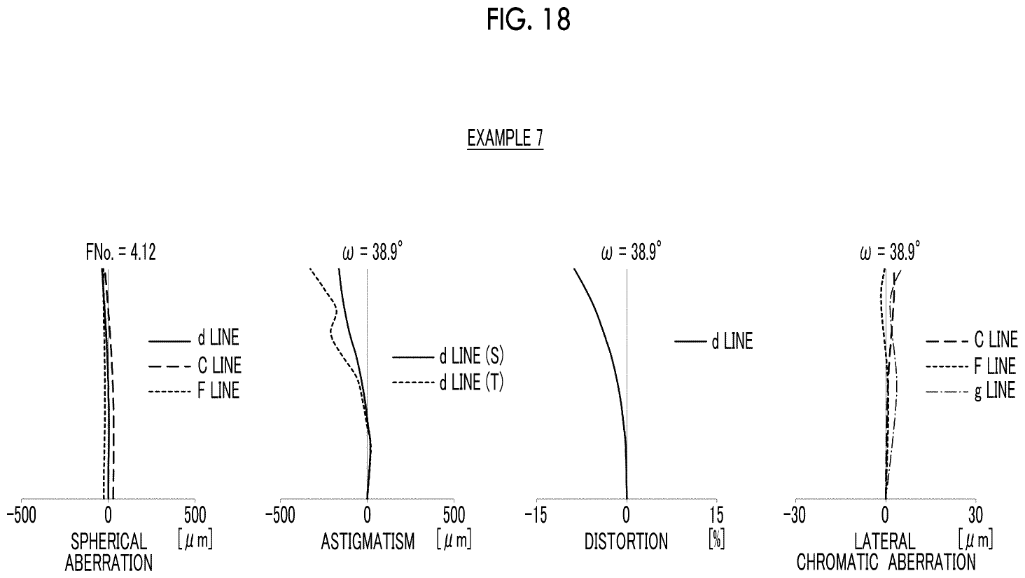

For the imaging lens according to Example 7, Table 19 shows basic lens data, Table 20 shows specifications and a variable surface spacing, Table 21 shows an aspherical coefficient, and FIG. 18 shows each aberration diagram.

TABLE 19
Example 7

| Sn | R | D | Nd | νd | θg, F |
|---|---|---|---|---|---|
| 1 | −41.6281 | 0.5099 | 1.54814 | 45.78 | 0.56859 |
| 2 | 14.7824 | 1.7439 | 1.87070 | 40.73 | 0.56825 |
| 3 | −678.8990 | 1.6000 | | | |
| 4(St) | ∞ | 2.8371 | | | |
| 5 | 44.4070 | 0.5101 | 1.56732 | 42.84 | 0.57436 |
| 6 | 21.8944 | 1.7536 | 1.74100 | 52.64 | 0.54676 |
| 7 | −31.7344 | 0.6696 | | | |
| 8 | −10.3567 | 0.7082 | 1.58144 | 40.89 | 0.57680 |
| 9 | 22.5566 | 3.7824 | 1.55032 | 75.50 | 0.54001 |
| 10 | −11.5219 | 0.1000 | | | |
| 11 | −29.1725 | 0.6000 | 1.53172 | 48.84 | 0.56309 |
| 12 | −180.3825 | 0.4008 | | | |
| *13 | −49.6646 | 2.6813 | 1.76802 | 49.24 | 0.55164 |
| *14 | −17.2827 | 4.4995 | | | |
| *15 | −29.7421 | 1.3426 | 1.68863 | 31.19 | 0.60069 |
| *16 | −320.2659 | 6.4547 | | | |
| 17 | −11.6404 | 0.9000 | 1.51633 | 64.14 | 0.53531 |
| 18 | −29.6656 | 0.5059 | | | |
| 19 | −18902.0713 | 4.1713 | 1.92119 | 23.96 | 0.62025 |
| 20 | −78.7016 | 5.9173 | | | |

TABLE 20
Example 7

| | |
|---|---|
| f | 29.3800 |
| Bf | 5.9173 |
| FNo. | 4.12 |
| 2ω[°] | 79.8 |

TABLE 21
Example 7

| Sn | 13 | 14 | 15 |
|---|---|---|---|
| KA | 5.3101280545E−02 | 2.0629483887E+00 | 1.3728693480E+00 |
| A4 | −1.3383572281E−05 | 5.4769243266E−05 | −2.5286683489E−04 |
| A6 | −3.0381121994E−07 | −6.0815433206E−07 | 3.9909876566E−06 |
| A8 | 1.5768315372E−08 | 2.2861969789E−08 | −2.0506952100E−07 |
| A10 | −2.1499391683E−11 | −2.3106040092E−10 | 8.3882999268E−09 |
| A12 | −3.7830079075E−12 | 2.5514685721E−12 | −1.9633382575E−10 |
| A14 | 5.7969741222E−14 | −2.5262128898E−14 | 2.7179941397E−12 |
| A16 | −4.0497630600E−16 | 1.3103287232E−16 | −2.1958578893E−14 |
| A18 | 1.4029493038E−18 | −3.1862543211E−19 | 9.5564448598E−17 |
| A20 | −1.9396241684E−21 | 2.9299553217E−22 | −1.7293684091E−19 |

| Sn | 16 |
|---|---|
| KA | 5.7347384824E+00 |
| A3 | 1.0207735719E−08 |
| A4 | −2.1156933247E−04 |
| A5 | −4.5646432951E−05 |
| A6 | 1.4519490023E−05 |
| A7 | 9.4739445382E−07 |
| A8 | −9.4657664740E−07 |
| A9 | 6.4049960823E−08 |
| A10 | 2.7139396244E−08 |
| A11 | −3.6508556623E−09 |
| A12 | −3.5603402331E−10 |
| A13 | 7.7767924793E−11 |
| A14 | 1.3417946473E−12 |
| A15 | −8.3760100778E−13 |
| A16 | 1.5877725688E−14 |
| A17 | 4.5471087214E−15 |
| A18 | −1.7872381819E−16 |
| A19 | −9.8974350031E−18 |
| A20 | 5.1594562210E−19 |

Table 22 shows corresponding values in Conditional Expressions (1) to (15) and (17) of the imaging lenses according to Examples 1 to 7. The imaging lenses according to Examples 1 to 7 satisfy Conditional Expressions (1) to (15) and (17). The imaging lenses according to Examples 1 to 7 have a point that Conditional Expression (16) is satisfied. Preferable ranges of the conditional expressions may be set using the corresponding values of the examples shown in Table 22 as the upper limits or the lower limits of the conditional expressions.

TABLE 22

| Expression | | | | | |
|---|---|---|---|---|---|
| Number | | Example 1 | Example 2 | Example 3 | Example 4 |
| (1) | TL/(f × tan ω) | 1.665 | 1.619 | 1.487 | 1.708 |
| (2) | Bf/f | 0.182 | 0.152 | 0.163 | 0.232 |
| (3) | FNo × (TL/f) | 5.906 | 5.694 | 5.955 | 5.393 |
| (4) | dG1/(f × tan ω) | 0.703 | 0.641 | 0.584 | 0.797 |
| (5) | dF/(f × tan ω) | 0.196 | 0.229 | 0.177 | 0.159 |
| (6) | fG1f/fG1 | 4.055 | 2.728 | 4.994 | 3.968 |
| (7) | fG1f/f | 2.612 | 1.874 | 3.220 | 2.697 |
| (8) | fG2/f | −1.103 | −1.440 | −1.378 | −1.018 |
| (9) | fG1/f | 0.644 | 0.687 | 0.645 | 0.680 |
| (10) | (1-βG1²) × βG2² | 2.410 | 2.119 | 2.406 | 2.165 |
| (11) | NG1rpa | 1.71433 | 1.71433 | 1.79033 | 1.73085 |
| (12) | θG1rpa + 0.0025 × | 0.6851 | 0.6851 | 0.6803 | 0.6885 |
| | νG1rpa | | | | |
| (13) | fG2p/fG2 | −2.272 | −1.478 | −1.658 | −2.488 |
| (14) | NG2p | 1.92119 | 1.92119 | 1.92119 | 1.92286 |
| (15) | θG2p + 0.0025 × | 0.6801 | 0.6801 | 0.6801 | 0.6912 |
| | νG2p | | | | |
| (17) | TL/f | 1.433 | 1.382 | 1.446 | 1.498 |

| Expression | | | | |
|---|---|---|---|---|
| Number | | Example 5 | Example 6 | Example 7 |
| (1) | TL/(f × tan ω) | 1.569 | 1.647 | 1.758 |
| (2) | Bf/f | 0.155 | 0.148 | 0.201 |
| (3) | FNo × (TL/f) | 5.808 | 5.960 | 5.846 |
| (4) | dG1/(f × tan ω) | 0.628 | 0.714 | 0.755 |
| (5) | dF/(f × tan ω) | 0.194 | 0.178 | 0.190 |
| (6) | fG1f/fG1 | 4.013 | 4.224 | 5.247 |
| (7) | fG1f/f | 2.560 | 2.637 | 3.395 |
| (8) | fG2/f | −1.252 | −0.876 | −0.952 |
| (9) | fG1/f | 0.638 | 0.624 | 0.647 |
| (10) | (1-βG1²) × βG2² | 2.457 | 2.565 | 2.389 |
| (11) | NG1rpa | 1.71433 | 1.68416 | 1.68645 |
| (12) | θG1rpa + 0.0025 × | 0.6851 | 0.6927 | 0.6940 |
| | νG1rpa | | | |
| (13) | fG2p/fG2 | −1.740 | −3.099 | −3.067 |
| (14) | NG2p | 1.92119 | 1.92119 | 1.92119 |
| (15) | θG2p + 0.0025 × | 0.6802 | 0.6802 | 0.6802 |
| | νG2p | | | |
| (17) | TL/f | 1.409 | 1.447 | 1.419 |

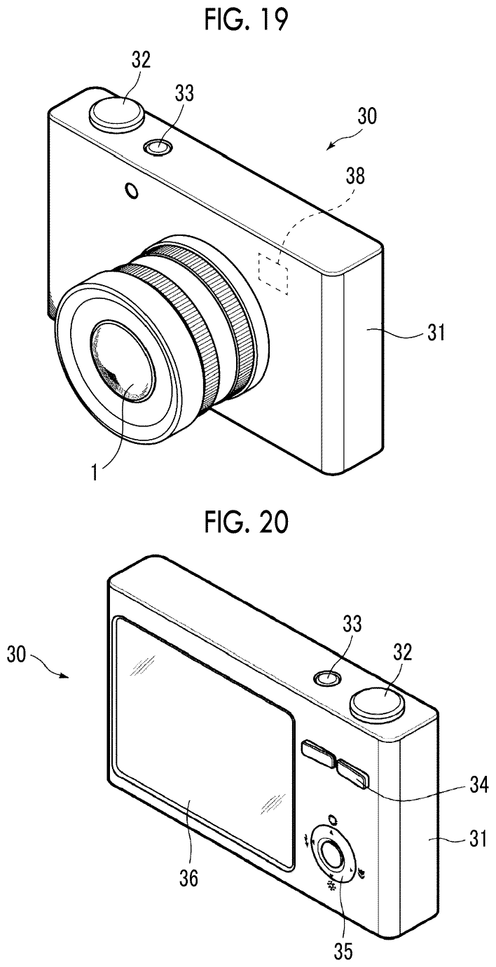

Hereinafter, an imaging apparatus according to the embodiment of the present disclosure will be described. FIGS. 19 and 20 are external views of a camera 30 that is the imaging apparatus according to the embodiment of the present disclosure. FIG. 19 is a perspective view of the camera 30, which is viewed from a front side, and FIG. 20 is a perspective view of the camera 30, which is viewed from a rear side. As an example, the camera 30 is a digital camera. The camera 30 includes the imaging lens 1 according to the embodiment of the present disclosure and the camera body 31 formed integrally with the imaging lens 1.

An upper surface of the camera body 31 is provided with a shutter button 32 and a power button 33. A rear surface of the camera body 31 is provided with an operation unit 34, an operation unit 35, and a display unit 36. The display unit 36 can display the captured image and an image within an angle of view before capturing.

An imaging element 38 is provided inside the camera body 31. The imaging element 38 outputs an imaging signal corresponding to the subject image formed by the imaging lens 1. For example, a charge-coupled device (CCD) or a complementary-metal-oxide semiconductor (CMOS) is used as the imaging element 38. A signal processing circuit (not shown), a recording medium (not shown), and the like are provided inside the camera body 31. The signal processing circuit generates the image by processing the imaging signal output from the imaging element 38. The recording medium is used for recording the generated image. In the camera 30, a still image or a moving image can be captured by pressing the shutter button 32, and the image data obtained by this capturing is recorded on the recording medium.

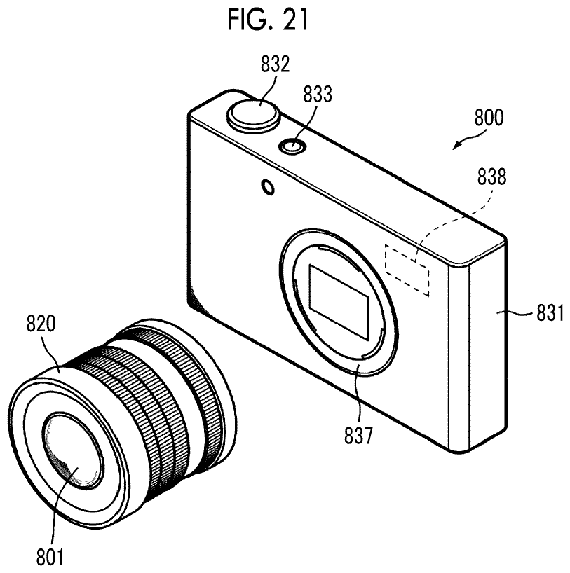

FIG. 21 is a perspective view of a camera 800 that is an imaging apparatus according to another embodiment of the present disclosure. As an example, the camera 800 is a so-called mirrorless-type digital camera. The camera 800 includes a camera body 831 and an interchangeable lens 820 that can be attached to and detached from the camera body 831. An imaging lens 801 according to the embodiment of the present disclosure is housed in the interchangeable lens 820.

An upper surface of the camera body 831 is provided with a shutter button 832 and a power button 833. An imaging aperture on which light from an imaging target is incident is provided in a center portion of a front surface of the camera body 831, a mount 837 is provided at a position corresponding to the imaging aperture, and the interchangeable lens 820 is mounted on the camera body 831 through the mount 837.

An imaging element 838 is provided inside the camera body 831. The imaging element 838 outputs an imaging signal corresponding to the subject image formed by the interchangeable lens 820. For example, a charge-coupled device (CCD) or a complementary-metal-oxide semiconductor (CMOS) is used as the imaging element 838. A signal processing circuit (not shown), a recording medium (not shown), and the like are provided inside the camera body 831. The signal processing circuit generates the image by processing the imaging signal output from the imaging element 838. The recording medium is used for recording the generated image. In the camera 800, a still image or a moving image can be captured by pressing the shutter button 832, and the image data obtained by this capturing is recorded on the recording medium.

While the technology of the present disclosure has been described above using the embodiment and the examples, the technology of the present disclosure is not limited to the embodiment and the examples, and can be subjected to various modifications. For example, the curvature radius, the surface spacing, the refractive index, the Abbe number, the aspherical coefficient, and the like of each lens are not limited to the values shown in the examples, and different values may be used.

In addition, the imaging apparatus according to the embodiment of the present disclosure is not limited to the above-described example and can have various aspects of, for example, a camera of a type other than a mirrorless type, a film camera, a video camera, and a security camera.

The following supplementary notes are further disclosed with respect to the embodiment and the examples described above.

### Supplementary Note 1

An imaging lens consisting of, in order from an object side to an image side, a first lens group and a second lens group, in which, during focusing, the first lens group moves along an optical axis, and the second lens group is fixed with respect to an image plane, a lens of the first lens group closest to the object side is a negative lens, and in a case in which a sum of a distance on the optical axis from a lens surface of the first lens group closest to the object side to a lens surface of the second lens group closest to the image side and a back focus of an entire system at an air conversion distance, in a state in which an infinite distance object is in focus, is denoted by TL, a focal length of the entire system in a state in which the infinite distance object is in focus is denoted by f, and a maximum half angle of view in a state in which the infinite distance object is in focus is denoted by ω, Conditional Expression (1) is satisfied, which is represented by 1.3<TL/(f×tan ω)<2.1 (1).

### Supplementary Note 2

The imaging lens according to supplementary note 1, in which the number of lenses included in the entire system is equal to or greater than 7 and equal to or less than 11.

### Supplementary Note 3

The imaging lens according to supplementary note 1 or 2, in which, in a case in which the back focus of the entire system at the air conversion distance in a state in which the infinite distance object is in focus is denoted by Bf, Conditional Expression (2) is satisfied, which is represented by 0.08<Bf/f<0.3 (2).

### Supplementary Note 4

The imaging lens according to any one of supplementary notes 1 to 3, in which, in a case in which an open F-number in a state in which the infinite distance object is in focus is denoted by FNo, Conditional Expression (3) is satisfied, which is represented by 4.3<FNo×(TL/f)<6.4 (3).

### Supplementary Note 5

The imaging lens according to any one of supplementary notes 1 to 4, in which, in a case in which a distance on the optical axis from the lens surface of the first lens group closest to the object side to a lens surface of the first lens group closest to the image side is denoted by dG1, Conditional Expression (4) is satisfied, which is represented by 0.45<dG1/(f×tan ω)<1 (4).

### Supplementary Note 6

The imaging lens according to any one of supplementary notes 1 to 5, in which, in a case in which a distance on the optical axis from a lens surface of the first lens group closest to the image side to a lens surface of the second lens group closest to the object side in a state in which the infinite distance object is in focus is denoted by dF, Conditional Expression (5) is satisfied, which is represented by 0.05<dF/(f×tan ω)<0.32 (5).

### Supplementary Note 7

The imaging lens according to any one of supplementary notes 1 to 6, in which the first lens group consists of, in order from the object side to the image side, a front side partial group, a stop, and a rear side partial group, and in a case in which a focal length of the front side partial group is denoted by fG1f, and a focal length of the first lens group is denoted by fG1, Conditional Expression (6) is satisfied, which is represented by 1.8<fG1f/fG1<8 (6).

### Supplementary Note 8

The imaging lens according to supplementary note 7, in which Conditional Expression (7) is satisfied, which is represented by 1.3<fG1f/f<5 (7).

### Supplementary Note 9

The imaging lens according to any one of supplementary notes 1 to 8, in which, in a case in which a focal length of the second lens group is denoted by fG2, Conditional Expression (8) is satisfied, which is represented by −2.5<fG2/f<−0.4 (8).

### Supplementary Note 10

The imaging lens according to any one of supplementary notes 1 to 9, in which, in a case in which a focal length of the first lens group is denoted by fG1, Conditional Expression (9) is satisfied, which is represented by 0.4<fG1/f<0.95 (9).

### Supplementary Note 11

The imaging lens according to any one of supplementary notes 1 to 10, in which, in a case in which a lateral magnification of the first lens group in a state in which the infinite distance object is in focus is denoted by βG1, and a lateral magnification of the second lens group in a state in which the infinite distance object is in focus is denoted by βG2, Conditional Expression (10) is satisfied, which is represented by 1.4<(1−βG1²)×βG2²<3.2 (10).

### Supplementary Note 12

The imaging lens according to any one of supplementary notes 1 to 11, in which the first lens group consists of, in order from the object side to the image side, a front side partial group, a stop, and a rear side partial group, and in a case in which an average value of refractive indexes of all positive lenses included in the rear side partial group at a d line is denoted by NG1rpa, an average value of Abbe numbers of all the positive lenses included in the rear side partial group based on the d line is denoted by νG1rpa, and an average value of partial dispersion ratios of all the positive lenses included in the rear side partial group between a g line and an F line is denoted by θG1rpa, Conditional Expressions (11) and (12) are satisfied, which are represented by 1.6<NG1rpa<1.86 (11), and 0.65<θG1rpa+0.0025×νG1rpa<0.72 (12).

### Supplementary Note 13

The imaging lens according to any one of supplementary notes 1 to 12, in which only one positive lens is included in the second lens group, and in a case in which a focal length of the positive lens in the second lens group is denoted by fG2p, and a focal length of the second lens group is denoted by fG2, Conditional Expression (13) is satisfied, which is represented by −4<fG2p/fG2<−1 (13).

### Supplementary Note 14

The imaging lens according to supplementary note 13, in which, in a case in which a refractive index of the positive lens in the second lens group at a d line is denoted by NG2, an Abbe number of the positive lens in the second lens group based on the d line is denoted by νG2p, and a partial dispersion ratio of the positive lens in the second lens group between a g line and an F line is denoted by θG2p, Conditional Expressions (14) and (15) are satisfied, which are represented by 1.88<NG2p<1.96 (14), and 0.67<θG2p+0.0025×νG2p<0.705 (15).

### Supplementary Note 15

The imaging lens according to any one of supplementary notes 1 to 14, in which a lens disposed on a side of the first lens group closest to the image side is a first aspherical lens having a positive refractive power.

### Supplementary Note 16

The imaging lens according to any one of supplementary notes 1 to 15, in which the second lens group includes a second aspherical lens, and in a case in which a height from the optical axis at a position of a maximum effective diameter on an image side surface of the second aspherical lens is denoted by hE2, an arbitrary height from the optical axis is denoted by h, an amount of sag of each point on the image side surface of the second aspherical lens at the height h is denoted by Sg2(h), and a second derivative of Sg2(h) with respect to h is denoted by d²Sg2(h)/dh², in a range of 0.5×hE2≤h≤hE2 on the image side surface of the second aspherical lens, Conditional Expression (16) is satisfied, which is represented by |d²Sg2(h)/dh²|>2×|d²Sg2(h/2)/dh²| (16).

### Supplementary Note 17

The imaging lens according to any one of supplementary notes 1 to 16, in which an object side surface of the negative lens of the first lens group closest to the object side is a concave surface.

### Supplementary Note 18

The imaging lens according to any one of supplementary notes 1 to 17, in which the first lens group includes a stop and a single lens that is disposed adjacent to the image side of the stop and that has a positive refractive power.

### Supplementary Note 19

The imaging lens according to any one of supplementary notes 1 to 18, in which the second lens group consists of, in order from the object side to the image side, a negative lens, a negative lens, and a positive lens.

### Supplementary Note 20

An imaging apparatus comprising the imaging lens according to any one of supplementary notes 1 to 19.

What is claimed is:

1. An imaging lens consisting of, in order from an object side to an image side, a first lens group and a second lens group,
wherein, during focusing, the first lens group moves along an optical axis, and the second lens group is fixed with respect to an image plane,
a lens of the first lens group closest to the object side is a negative lens, and
in a case in which
a sum of a distance on the optical axis from a lens surface of the first lens group closest to the object side to a lens surface of the second lens group closest to the image side and a back focus of the imaging lens at an air conversion distance, in a state in which an infinite distance object is in focus, is denoted by TL,
a focal length of the imaging lens in a state in which the infinite distance object is in focus is denoted by f, and
a maximum half angle of view in a state in which the infinite distance object is in focus is denoted by ω,
Conditional Expression (1) is satisfied. which is represented by
$$1. 3 < TL / ( f \times tan ω ) < 2.1 . \qquad ( 1 )$$

2. The imaging lens according to claim 1,
wherein the number of lenses included in the imaging lens is equal to or greater than 7 and equal to or less than 11.

3. The imaging lens according to claim 1,
wherein, in a case in which the back focus of the imaging lens at the air conversion distance in a state in which the infinite distance object is in focus is denoted by Bf,
Conditional Expression (2) is satisfied, which is represented by
$$0.08 < Bf / f < 0.3 . \qquad ( 2 )$$

4. The imaging lens according to claim 1,
wherein, in a case in which an open F-number in a state in which the infinite distance object is in focus is denoted by FNo,
Conditional Expression (3) is satisfied, which is represented by
$$4.3 < FNo \times ( TL / f ) < 6.4 . \qquad ( 3 )$$

5. The imaging lens according to claim 1,
wherein, in a case in which a distance on the optical axis from the lens surface of the first lens group closest to the object side to a lens surface of the first lens group closest to the image side is denoted by dG1,
Conditional Expression (4) is satisfied, which is represented by
$$0. 45 < dG 1 / ( f \times tan ω ) < 1. \qquad ( 4 )$$

6. The imaging lens according to claim 1,
wherein, in a case in which a distance on the optical axis from a lens surface of the first lens group closest to the image side to a lens surface of the second lens group closest to the object side in a state in which the infinite distance object is in focus is denoted by dF,
Conditional Expression (5) is satisfied, which is represented by
$$0.05 < dF / ( f \times tan ω ) < 0.32 . \qquad ( 5 )$$

7. The imaging lens according to claim 1,
wherein the first lens group consists of, in order from the object side to the image side, a front side partial group, a stop, and a rear side partial group, and
in a case in which
a focal length of the front side partial group is denoted by fG1f, and
a focal length of the first lens group is denoted by fG1,
Conditional Expression (6) is satisfied, which is represented by
$$1.8 < fG 1 f / fG 1 < 8. \qquad ( 6 )$$

8. The imaging lens according to claim 7,
wherein Conditional Expression (7) is satisfied, which is represented by
$$1.3 < fG 1 f / f < 5. \qquad ( 7 )$$

9. The imaging lens according to claim 1,
wherein, in a case in which a focal length of the second lens group is denoted by fG2,
Conditional Expression (8) is satisfied, which is represented by
$$- 2.5 < fG 2 / f < - 0.4 . \qquad ( 8 )$$

10. The imaging lens according to claim 1,
wherein, in a case in which a focal length of the first lens group is denoted by fG1,
Conditional Expression (9) is satisfied, which is represented by
$$0.4 < fG 1 / f < 0 \text{.95} . \qquad ( 9 )$$

11. The imaging lens according to claim 1,
wherein, in a case in which
a lateral magnification of the first lens group in a state in which the infinite distance object is in focus is denoted by βG1, and
a lateral magnification of the second lens group in a state in which the infinite distance object is in focus is denoted by βG2,
Conditional Expression (10) is satisfied, which is represented by
$$1. 4 < ( 1 - βG {1}^{2} ) \times β G {2}^{2} < 3.2 . \qquad ( 10 )$$

12. The imaging lens according to claim 1,
wherein the first lens group consists of, in order from the object side to the image side, a front side partial group, a stop, and a rear side partial group, and
in a case in which
an average value of refractive indexes of all positive lenses included in the rear side partial group at a d line is denoted by NG1rpa,
an average value of Abbe numbers of all the positive lenses included in the rear side partial group based on the d line is denoted by νG1rpa, and
an average value of partial dispersion ratios of all the positive lenses included in the rear side partial group between a g line and an F line is denoted by θG1rpa,
Conditional Expressions (11) and (12) are satisfied, which are represented by
$$1.6 < NG 1 rpa < 1.86 , and \qquad ( 11 )$$
$$0.65 < θ G 1 rpa + 0.0025 \times vG 1 rpa < 0.72 . \qquad ( 12 )$$

13. The imaging lens according to claim 1,
wherein only one positive lens is included in the second lens group, and
in a case in which
a focal length of the positive lens in the second lens group is denoted by fG2p, and
a focal length of the second lens group is denoted by fG2,
Conditional Expression (13) is satisfied, which is represented by
$$- 4 < fG 2 p / fG 2 < - 1. \qquad ( 13 )$$

14. The imaging lens according to claim 13,
wherein, in a case in which
a refractive index of the positive lens in the second lens group at a d line is denoted by NG2p,
an Abbe number of the positive lens in the second lens group based on the d line is denoted by νG2p, and
a partial dispersion ratio of the positive lens in the second lens group between a g line and an F line is denoted by θG2p,
Conditional Expressions (14) and (15) are satisfied, which are represented by
$$1. 88 < NG 2 p < 1.96 , and \qquad ( 14 )$$
$$0.67 < θ G 2 p + 0.0025 \times v G 2 p < 0.7 5. \qquad ( 15 )$$

15. The imaging lens according to claim 1,
wherein a lens disposed on a side of the first lens group closest to the image side is a first aspherical lens having a positive refractive power.

16. The imaging lens according to claim 1,
wherein the second lens group includes a second aspherical lens, and
in a case in which
a height from the optical axis at a position of a maximum effective diameter on an image side surface of the second aspherical lens is denoted by hE2,
an arbitrary height from the optical axis is denoted by h,
an amount of sag of each point on the image side surface of the second aspherical lens at the height h is denoted by Sg2(h), and
a second derivative of Sg2(h) with respect to h is denoted by d²Sg2(h)/dh²,
in a range of 0.5×hE2≤h≤hE2 on the image side surface of the second aspherical lens,
Conditional Expression (16) is satisfied, which is represented by
$$\vert {d}^{2} Sg 2 ( h ) / {dh}^{2} \vert > 2 \times \vert {d}^{2} Sg 2 ( h / 2 ) / {dh}^{2} \vert . \qquad ( 16 )$$

17. The imaging lens according to claim 1,
wherein an object side surface of the negative lens of the first lens group closest to the object side is a concave surface.

18. The imaging lens according to claim 1,
wherein the first lens group includes a stop and a single lens that is disposed adjacent to the image side of the stop and that has a positive refractive power.

19. The imaging lens according to claim 1,
wherein the second lens group consists of, in order from the object side to the image side, a negative lens, a negative lens, and a positive lens.

20. An imaging apparatus comprising:
the imaging lens according to claim 1.
